(19) United States
(12) Patent Application Publication
(10) Pub. No.: US 2008/0055049 A1
(43) Pub. Date: Mar. 6, 2008

(54) Searching methods

(76) Inventors: Lawrence R. Weill, Seal Beach, CA (US); Edward F. Tuck, West Covina, CA (US); Mark A. Sturza, Encino, CA (US); Thomas N. Giaccherini, Carmel Valley, CA (US)

Correspondence Address: Giaccherini, Post Office Box 1146, Carmel Valley, CA, 93924, US

(21) Appl. No.: 11/881,153

(22) Filed: Jul. 24, 2007

Related U.S. Application Data
(60) Provisional application No. 60/834,025, filed on Jul. 28, 2006.

(51) Int. Cl. H04Q 3/02

(52) U.S. Cl. 340/10.31

(57) ABSTRACT

Methods and apparatus for using an energy emanating device that finds a person (17a,b) object or system based on preselected attributes (33) stored in the energy emanating device (10) are disclosed. Searching Methods are used to compare the attributes (33) of individuals, and a match is determined based upon the correlation of these attributes (33). The matching is accomplished using a variety of algorithms, including a “Distance Formula.” In alternative embodiments, the invention may be used in a search engine.

### CROSS-REFERENCE TO A RELATED PENDING U.S. PATENT APPLICATION

This Non-Provisional patent application is related to Pending Provisional U.S. Patent Application Ser. No. 60/834,025, filed on 28 Jul. 2006. The Applicants hereby claim priority for any subject matter that is commonly disclosed in the U.S. Provisional Application and in this Non-Provisional patent application.

### FIELD OF THE INVENTION

One embodiment of the present invention pertains to methods and apparatus for using an electronic device to find a person or system that meets criteria specified by a user and/or to establish mutual compatibility between or among two or more people or systems. More particularly, one preferred embodiment of the invention uses a small radiating device which utilizes radio, optical, ultrasonic or other means that automatically and continuously or periodically emits a signal which interrogates other similar devices.

When the user's device finds another person or system whose device returns a signal that matches the user's pre-specified criteria, the user is alerted by a visual and/or audible signal. The matching is accomplished using a variety of algorithms, including a “Distance Formula.”

In another embodiment of the invention, the Distance Formula is incorporated into a search engine, and is used to find information, a product or a replacement part on the Internet, or in some other database.

### BACKGROUND OF THE INVENTION

Over the past decade, a variety of Internet dating services have been established. These services, such as match.com™ or e-harmony.com™, offer on-line presentations of information and photos of individuals. None of these services furnishes a device, method or system for matching individuals who are simultaneously present within a pre-determined physical region. The development of a device or system that could help individuals find friends or mates in real time within a pre-determined physical region would constitute a major technological advance, and would satisfy long-felt needs and aspirations of the Internet dating industry and of Humanity in general.

Conventional search engines such those provided by Google™ and Yahoo!® are based on techniques that involve the popularity of webpages. These types of searches may sometimes fail to provide focused search results. The development of a method that could offer Internet or other database searches that furnish focused and accurate results would constitute a major technological advance, and would satisfy long-felt needs and aspirations of the information and computing industries.

### SUMMARY OF THE INVENTION

### I. A First Group of Embodiments

Using Searching Methods to Find a Match

One embodiment of the present invention provides a simple miniaturized electronic device that enables individuals to find a friend, a mate or someone with a specific interest or skill. In one embodiment of the invention, a man or a woman may program a MateFinder™ to help find an ideal match. In one particular embodiment, the MateFinder™ comprises a radio and a microprocessor with a non-volatile memory, such as a static RAM. Information that describes both the user and the ideal match can be written to the non-volatile memory. The radio automatically and periodically broadcasts a “seeking signal” over a short range. When the seeking signal is received by another MateFinder™, it is analyzed to determine the degree of correlation with the receiver's preferences. If the degree of correlation exceeds a preset minimum, the sender, the receiver, or both are alerted.

One embodiment of the invention uses the Searching Methods to compare the attributes of individuals, and to then determine a good match based on the comparison of the attributes. In an alternative embodiment, the Applicants' Searching Methods may be utilized without a MateFinder to determine a good match when used in combination with an Internet dating service.

### II. A Second Group of Embodiments

Using Searching Methods as part of an Internet Search Engine

A second embodiment of the present invention offers a search tool for a database, such as the Internet. This method uses the attributes of the target of the search, rather than a search that is based on “page-ranking” searches that conduct searches based on the previous popularity of all entries in a database that are available to the searcher.

### III. A Third Group of Embodiments

More Advanced Searching Methods with Additional User Inputs & Controls

In a third embodiment, additional controls and inputs are provided for the user to optimize his or her search.

### IV. A Fourth Group of Embodiments

A fourth embodiment of the invention may be used to create a website for finding products or parts in situations when a keyword search is not helpful.

An appreciation of the other aims and objectives of the present invention, and a more complete and comprehensive understanding of this invention, may be obtained by studying the following description of preferred and alternative embodiments, and by referring to the accompanying drawings.

### A BRIEF DESCRIPTION OF THE DRAWINGS

FIG. 1 offers a view of men and women attending a party. The man has a MateFinder™ clipped to his belt. Some of the women at the party have a MateFinder™ clipped to a purse or belt, or concealed in their clothing. The man's MateFinder™ produces a short-range radio signal that interrogates other MateFinders™ that are nearby. The interrogation signal may broadcast a description of the man and seeks another MateFinder™ that stores a list of qualities, characteristics or criteria that describe the gentleman's aspirations, preferences or requirements in a mate. When the interrogation signal finds a good match, the man is alerted by a visual or audible alert. If the man's own attributes match those sought by one of the women, the MateFinder™ may alert her to the presence of the man.

FIG. 2 supplies a perspective view of one particular embodiment of the invention, which may be clipped to a man's belt or to a woman's purse, or which may be concealed in the clothing of either. The MateFinder may also be incorporated into a bracelet, watch, necklace, tietack, shoe, hat or some other fashionable item or article.

FIG. 3 illustrates a woman who has visited a website using her personal computer. In this example, the website is located at www.e-pheromone.com. She has connected her MateFinder™ device to the USB port of her computer, and is programming her MateFinder™ with her own attributes, as well as with her preferences in a mate.

FIG. 4 is a flowchart that explains how a user employs the MateFinder™ to help find a person with characteristics that match the user's preferences.

FIG. 5 shows the same woman at some sort of social event, perhaps at the beach, in a park, at a concert or attending a sporting event. The woman's MateFinder™ has found a match in the crowd, and alerts her to his presence.

FIG. 6 exhibits the operation of a pair of MateFinders™. When the man's device finds a woman's MateFinder™ that presents a good match, his device alerts him. In an alternative embodiment, the woman may respond by using her cellular telephone to send a message back to her prospective match, or by using a text-message feature of her MateFinder™.

FIG. 7 is a simplified schematic diagram of one embodiment of the present invention.

FIG. 8 is a more detailed schematic diagram which exhibits a particular implementation of the present invention.

FIG. 9 is a flow-chart that outlines a basic design for a software program that may be utilized in one embodiment of the invention.

FIGS. 10, 11, 12 and 13 are flow charts which illustrate correlation methods that may be used to implement the present invention.

FIG. 14 is an abstract representation of a database or collection of information, such as the Internet.

FIG. 15 is a map which shows the sources of information in a master set and each of the selected attributes.

FIG. 16 presents a Table of Shortest Distances, which is created by selecting the shortest distance that has been measured between one attribute and one source for each attribute. The shortest distance signifies the highest relevance.

FIG. 17 exhibits the combination of Searching Methods with a conventional page-rank search.

FIG. 18 depicts a flow chart for one specific matching algorithm.

FIG. 19 depicts a flow chart for an alternative matching algorithm.

### DETAILED DESCRIPTION OF PREFERRED & ALTERNATIVE EMBODIMENTS

### I. A First Group of Embodiments

Using Searching Methods to Find a Match

The present invention comprises methods and apparatus for finding someone or something with specific attributes using a radio device. In one embodiment of the invention, a MateFinder™ 10, which resembles a pager, may be used by a man or a woman to find a match.

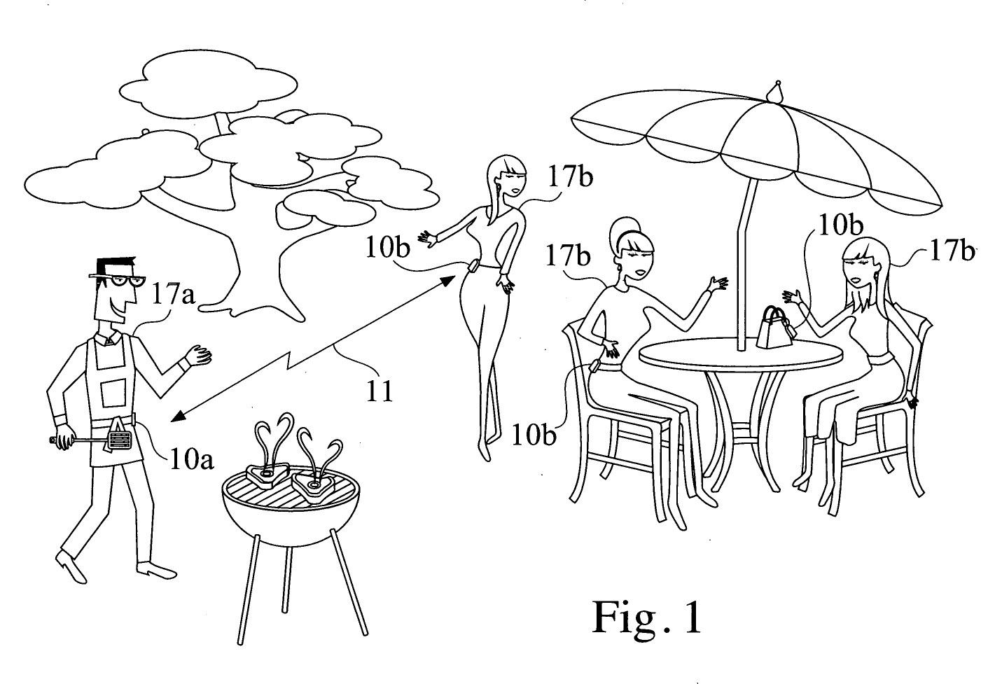

FIG. 1 is a representation of a private party. One of the hopes of some of the men and women who attend the party is that of finding a friend or a mate. In accordance with one embodiment of the present invention, a man 17a is shown wearing a MateFinder™ 10a clipped to his belt. A group of women 17b standing around or sitting at a table also have MateFinders 10b, which are clipped to their belts or purses or are concealed in their clothing.

In general, the MateFinder™ 10 is an electronic device which uses a radio to help find someone or something which fits a predetermined description or some preselected criteria. The term “radio” is intended to encompass any device or system that communicates wirelessly over a distance.

The radio may comprise any communication means, signal conveying device, system or process for emanating and/or receiving data, messages, information, sensation, manifestation, pattern, perception, or other intelligence. The radio used by the present invention may comprise a transceiver. This transceiver may include a separate transmitter and a separate receiver, or may utilize a single circuit for both functions. The transceiver may operate only as a transmitter for a period of time, may operate only as a receiver for a period of time or may transmit and receive generally simultaneously.

In this Specification and in the Claims that follow, the MateFinders 10 are generally identified as 10a when used by a man or an unspecified “first user” 17a, and as 10b when used by a woman or unspecified “second user” 17b. The use of the reference characters ending in “a” and “b”, which are also recited in the Claims as the “first” and “second” transceivers, 10a and 10b, are intended to assist the reader in understanding the invention, but do not connote any substantive differences in the device 10.

The man's MateFinder™ 10a continuously emits an automatic and generally continuous radio seeking or interrogation signal 11. This signal 11 illuminates or interrogates other MateFinder radios that are within range. The man 17a has programmed his MateFinder 10a with a set of attributes that describes himself, and this information is conveyed by the signal 11 emitted by his MateFinder. This signal 11 may also convey a description of the woman that he is interested in finding.

If the man's MateFinder signal finds a woman who fits his preselected set of criteria, his MateFinder issues a visual and/or audible alert. If the man's MateFinder signal contains a description that matches the woman's predetermined description of a suitable man, the woman's MateFinder alerts her to his presence. The location and/or identity of each person carrying the MateFinder is not initially available to the users. For example, in one possible use, exemplars of the device would be worn (possibly concealed) by a number of users attending a large private party or public function. Each user's MateFinder would emit its own interrogation signal, for example, first interrogation signal 11a, and second interrogation signal 11b. Users would be alerted to the presence of compatible types, along with an indication of the degree of correlation found and whether a selected matching signal's position is masked. The user would then have the option of unmasking his or her position to the emitter of a specific signal, possibly by changing the modulation scheme to one that allows its strength to be detected. Users could then approach each other by maximizing their indication of the other's signal strength. It should be possible to see the target person at a safe distance before making further contact. The present invention reduces the risk that is inherent in Internet or other forms of remote or electronic dating by allowing a user to evaluate a prospective match in person before initiating contact. Some of the embodiments may also enhance the user's privacy, because his or her personal data are not sent to a website or other third party.

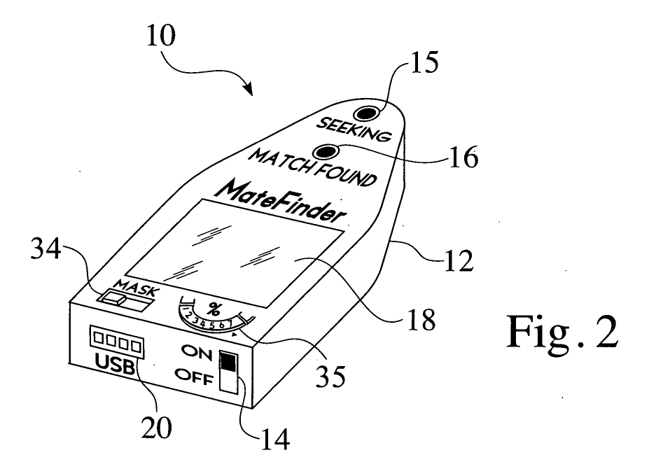

FIG. 2 furnishes a perspective view of one embodiment of the MateFinder device 10. A housing 12 made of plastic or some other suitable material encloses a radio (not shown in FIG. 2). A power switch 14 is located on the base of the housing 12. When the power switch 14 is turned to the “ON” position, an LED 15 labeled “SEEKING” flashes periodically to indicate that the MateFinder™ 10 is emitting a signal. When the MateFinder™ finds a match, an LED 16 labeled “MATCH FOUND” is illuminated. The illumination of the “MATCH FOUND” LED 16 may be accompanied by an audible alarm or tone, vibration or some other suitable means for alerting the user. In an embodiment in which two MateFinders 10 are used, each MateFinder includes a match indicator, 16a and 16b. A miniature LCD screen 18 is situated on one side of the MateFinder 10. This screen 18 is used to read messages which may be sent by the person who is detected by the seeking signal 11, or to view a list of possible matches detected by the MateFinder. A USB port 20 or some other suitable port for connecting the MateFinder 10 to a personal computer or some other appliance or device is located on the base of the device. In an alternative embodiment, the USB port 20 may be replaced or enhanced by a wireless connection. A “Mask” switch 34 enables the user to prevent another MateFinder from locating the user. A correlation switch 35 enables the user to adjust the level of matching that is performed by the MateFinder.

For example, if the user turns the thumbwheel 35 toward the “10” indicator on the wheel, he or she is instructing the MateFinder to seek out a stronger or higher level of correlation between the preselected qualities or attributes stored in his or her MateFinder and a potential candidate. By turning the thumbwheel 35 down towards “1”, the MateFinder reports matches that represent lower levels of correlation between preselected attributes and candidates.

In alternative implementations of the invention, the MateFinder 10 may be built into a bracelet, a necklace, a tie-clip, a hat, a shoe or some other suitable fashion item, article of clothing or ornament.

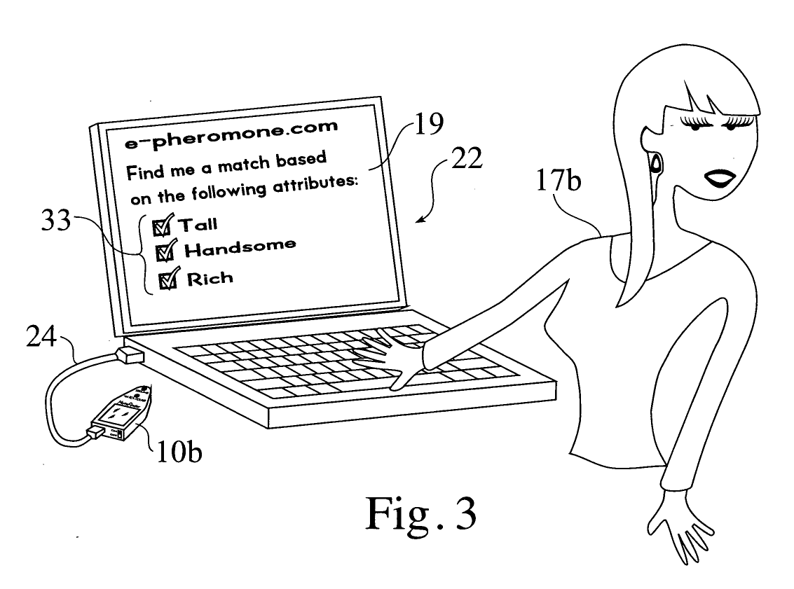

FIG. 3 depicts a woman 17b who has visited a website 19, www.e-pheromone.com. After connecting her MateFinder 10b to the USB port of her personal computer 22 with a cable 24, she is able to program her MateFinder 10b with two sets of attributes 33: a first set of attributes 33a that describes herself, and a second set of attributes 33b that describes her ideal mate. In general, an attribute is any form of data, criteria, information, measure of suitability, complementarity or compatibility; qualities or characteristics that describe a person, item, system, device or thing being sought by a user of the present invention. In one embodiment, two sets of attributes are employed, a first 33a, which pertain to the “seeking” user, and a second 33b, which pertain to the “target” user. Both of these sets of information may be entered into the personal computer 22 in response to prompts from the pages of the website 19. Software running on a server (not shown) which hosts the website then sends the data back to the woman's computer 22, where it is conveyed to the attached MateFinder 10 over the USB cable 24. In an alternative embodiment, the connection between the personal computer 22 and the MateFinder 10 may be wireless.

In one embodiment of the invention, the MateFinder may be programmed using a personal computer 22 with an Internet connection and a website 19. Alternatively, the programming may be accomplished with just a personal computer 22 loaded with suitable software. In an advanced embodiment, the MateFinder may be programmed without any other device or software by communicating directly with a website 19 over a wireless connection, or may be programmed using a keyboard or some other input means associated with the MateFinder.

In another embodiment, the website can also provide aliases for its members' e-mail addresses. In this way, e-mail is forwarded to their true address, which is kept secret. If a suitor is too persistent, a user can easily change her alias. The user may also block e-mails from unwanted suitors. The website may also provide a similar service for cellular telephone numbers, by furnishing a call-forwarding feature for a discreet call-in number.

The attributes 33 which may be selected by the user are virtually unlimited. In the case of a dating service, attributes 33 may be selected from an existing list of attributes 33. As an example, Table One presents attributes 33 which the website 19 displays may include:

TABLE ONE

| Category | Attribute |
|---|---|
| Gender | Male, Female |
| Age | |
| Appearance | Handsome/Knockout, |
| | Attractive/Cute |
| Marital history | Single, Divorced |
| Residence location | |
| Height | Tall, Average, Short |
| Weight | |
| Hair Color | Blonde, Brunette, Redhead |
| Occupation & Income | |
| Religiosity | Yes/No; Denomination |
| Political preferences | Conservative, Liberal, None |
| Interests or hobbies | |
| Educational level | |
| Social Class Marker | |

In this “electronic dating” embodiment, the user generally creates two sets of attributes 33: a first set 33a to describe herself or himself, and a second set 33b to describe his or her ideal match. In another embodiment, the user may only select one set, either only attributes that describe herself 33a, or only attributes that describe a mate 33b. A set of attributes 33 may include any number of qualities, numbering from one to a large number. Both sets of attributes 33 are stored in a non-volatile memory that is housed within the MateFinder 10. In one embodiment of the invention, one MateFinder 10a with a first memory 32a is employed to find a second MateFinder 10b with a second memory 32b. These preselected attributes may be revised by visiting the website 19, or may be generated using a software template provided with the MateFinder, which is then reprogrammed to incorporate the new data. In an alternative embodiment of the invention, the MateFinder 10 may be programmed directly using voice commands, or by using a keypad built into the device (not shown).

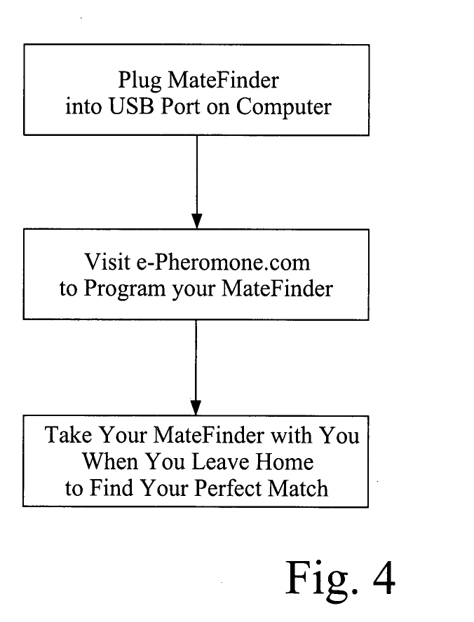

FIG. 4 offers a basic flowchart that describes how this embodiment of the invention is used. After acquiring a MateFinder 10, the user connects it to a personal computer 22. The user visits a website 19 to select two sets of attributes 33 that are stored in his or her device, or uses a software template supplied with the MateFinder. When he or she is ready to enter a social setting, or simply leaves home, he or she then turns the MateFinder on, and takes it along.

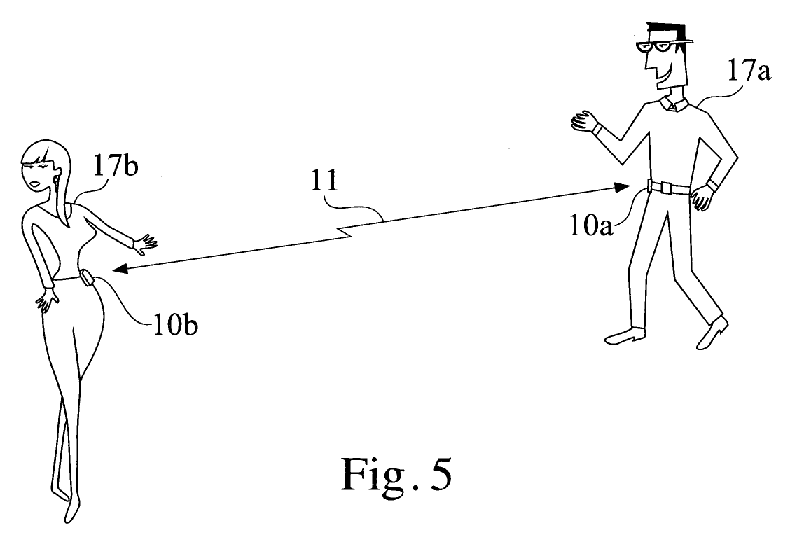

As shown in FIG. 5, the automatic and continuous seeking signal 11 finds a match. The woman 17b shown in FIG. 5, who may be attending a party, a concert or a sporting event, finds a match 17a based on her preselected attributes 33.

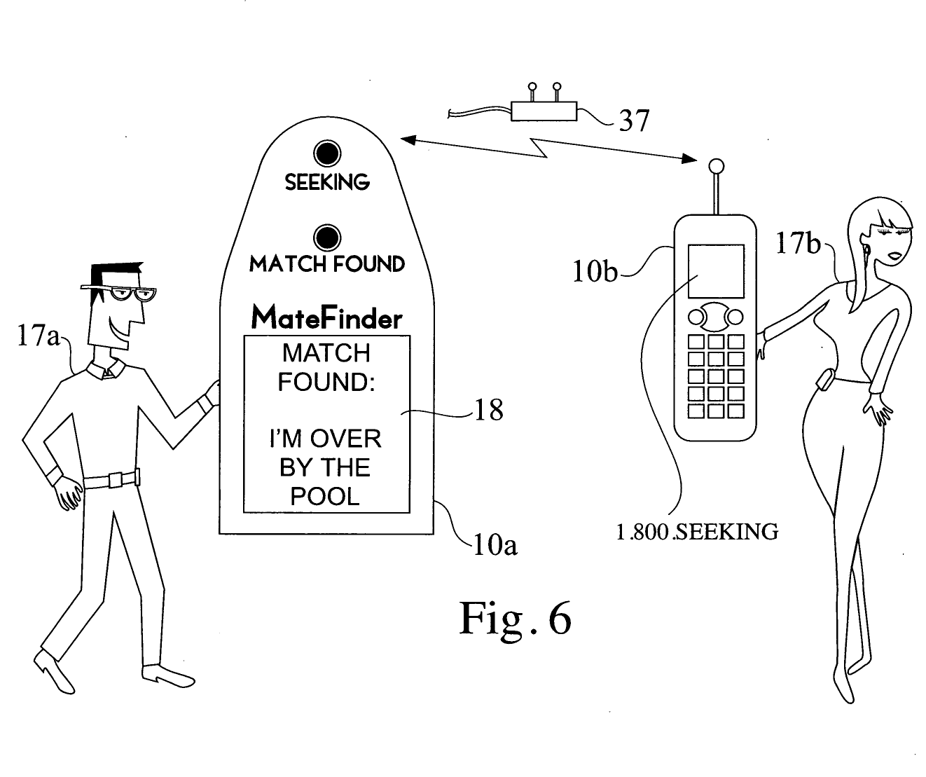

FIG. 6 reveals the operation of a more complex embodiment of the invention. After a man's MateFinder 10a has located a suitable match 17b, the man's MateFinder 10a conveys an address or some other identification message to the woman who has been matched. Her message may appear on the screen 18 of his device 10a. The woman 17b then has the option to communicate with the man 17a immediately. In one embodiment of the invention, the woman 17b may use her cellular phone to call a standard phone number, toll free number (such as 1.800.SEEKING) or a “900” number that generates revenue. In another embodiment, the MateFinder itself can provide text-messaging, either through its radiated signal or through a local network 37 or the Internet. The address or identification information which has been sent to her MateFinder 10b by the man's MateFinder 10a is displayed on her LCD screen 18. After dialing the toll-free number, she enters this address or identification information, and is then prompted to enter a text message, or to record a voice message.

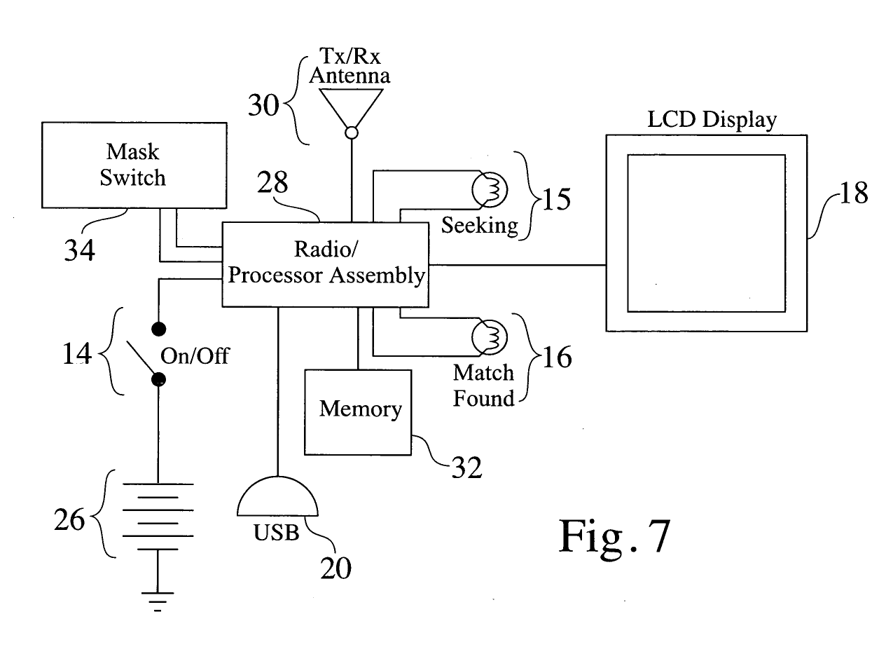

FIG. 7 is a simplified schematic diagram of the circuitry that may be employed to implement one embodiment of the present invention. The power switch 14 controls the flow of energy from a battery 26 that powers the MateFinder 10. When the MateFinder 10 is turned on, a radio/processor assembly 28 automatically and continuously emits a seeking signal 11 using antenna 30 over a short range. A USB port 20 is connected to the radio/processor assembly 28. The antenna 30 may be contained within the housing 12. When the radio/processor assembly 28 is broadcasting, the “SEEKING” LED 15 flashes periodically. When a match is found, the “MATCH FOUND” LED 16 illuminates, or some other audible or vibrating alarm is activated. The radio/processor assembly 28 is also connected to the LCD screen 18, which may be used to display short text messages that are received from another MateFinder 10.

The radio/processor assembly 28 is also connected to a memory 32, which is used to store attributes that describe the user and his or her ideal mate. The memory 32 may comprise any suitable non-volatile device, including, but not limited to a flash memory or hard-drive. In an alternative embodiment, a “MASK” switch 34, which is connected to microprocessor 36, may be included to allow the user to mask his or her location.

A suitable frequency for the radio emissions, such as one of the unlicensed “ISM” or “RF device” bands set aside by the United States Federal Communications Commission, is selected to avoid creating unwanted interference. The MateFinder 10 may be configured to emit and/or receive a variety of signals or emanations of energy. In the United States, some embodiments of the invention may use the 900 MHz, 2.1 GHz, 5.8 GHz, 59-64 GHz or some other radio frequency band. In other countries, other suitable frequency bands may be selected for the operation of the present invention. Other embodiments of the invention may employ light energy, voice commands, audible tones or ultrasonic emissions; mechanical, physical or chemical manifestations; radioactivity, or any other suitable means for communication.

In a more advanced embodiment of the invention, some or all of the discrete components described in FIG. 7 may be integrated on a single computer chip.

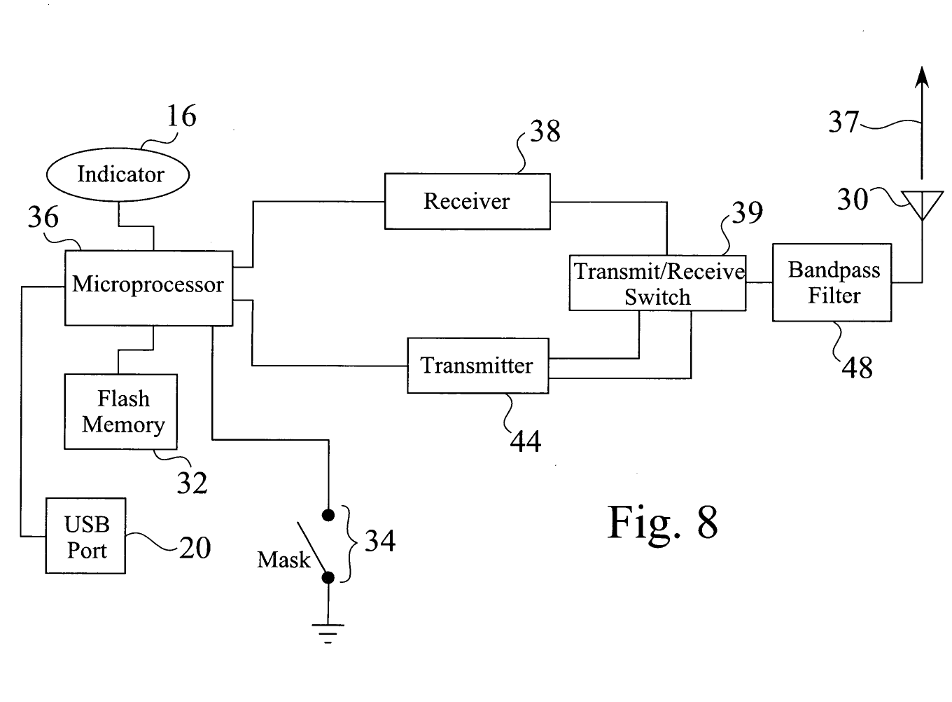

FIG. 8 provides a schematic diagram that illustrates one particular implementation of the invention. A microprocessor 36 is connected to a flash memory 32, a USB port 20 and an indicator 16. The microprocessor 36 is also connected to a receiver assembly 38 and a transmitter assembly 44. The outputs of the receiver 38 and the transmitter 44 are connected to an automatic transmit-receive switch 39, which, in turn, is connected to a bandpass filter 48 and an antenna 30.

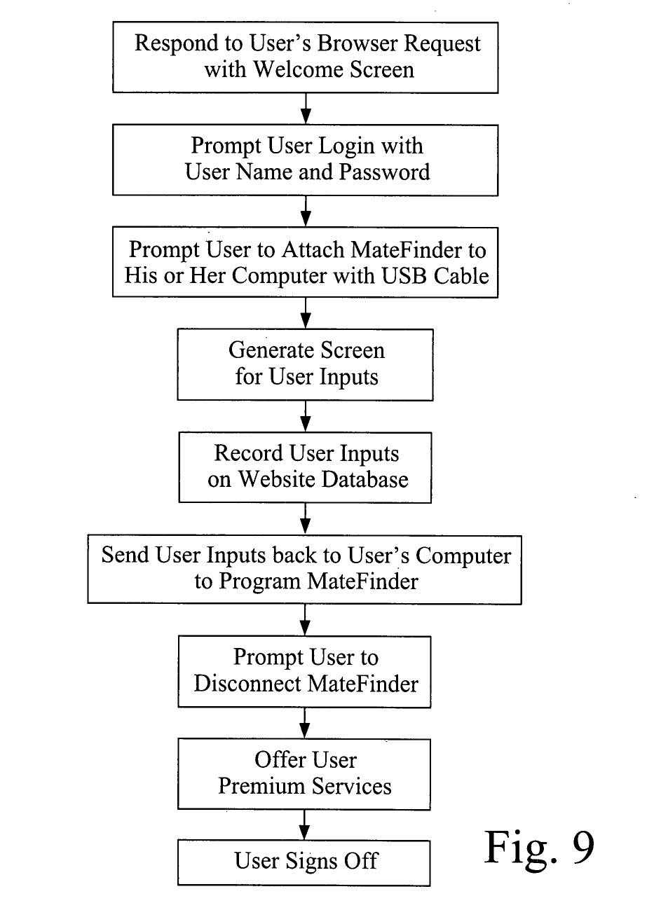

FIG. 9 offers a flowchart which depicts the basic operational steps of a particular software program that may reside at the website 19 used by the present invention. In the first step of the process, a user visits the website 19, such as e-pheromone.com. The user's browser requests information from the website 19, and the website responds by sending the user a welcome screen. The welcome screen invites the user to either create a new account, or to login to his or her existing account with a username and a password.

After the user has logged in for the first time, a new screen prompts the user to attach his or her MateFinder to his or her computer with a USB cable. After the user's computer has reported back to the website that the MateFinder is connected, the website generates a new screen that prompts the user to program his or her MateFinder using menu selections and/or a set of input fields.

After the user completes the selections, this information is recorded on a website database, and the website 19 sends the data back to the user's computer in a form that may be recorded in the MateFinder's memory. The user then disconnects the MateFinder, and may be offered a variety of premium services, such as background checks, certification of attributes or compatibility analysis, before he or she logs off.

In another alternative embodiment of the invention, the MateFinder may be designed to work in combination with an existing WiFi or similar wireless network 37 that is operating in the place where the user happens to be located. The user would be able to employ the wireless LAN or wired network (via a cable to the MateFinder), and would then be able to take advantage of all the connections offered by the Internet.

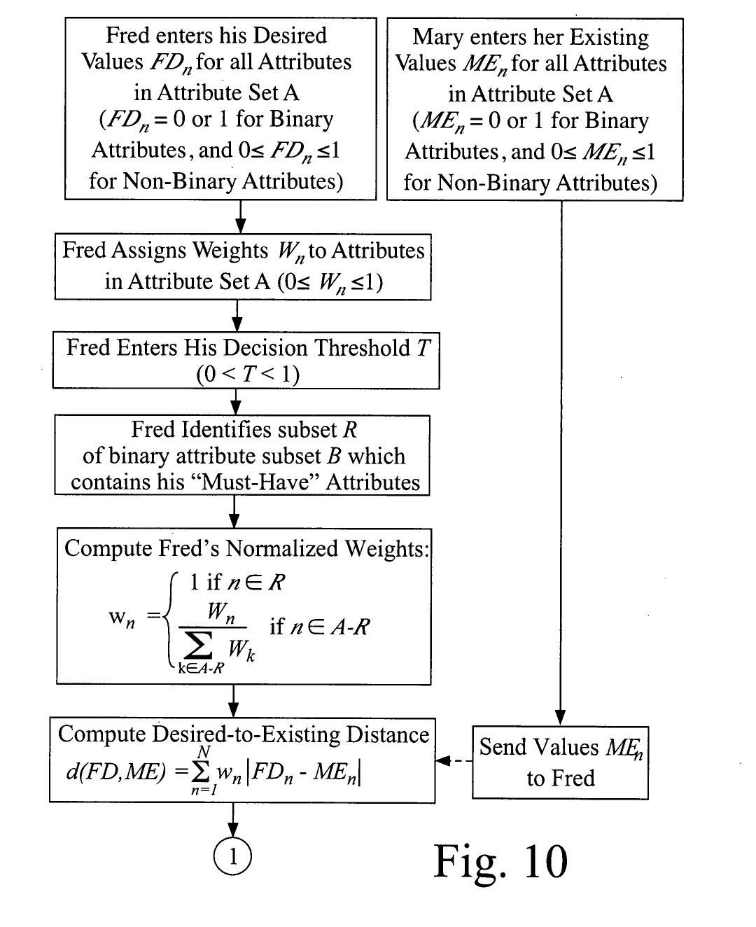

FIGS. 10, 11, 12 and 13 are flowcharts which depict Searching Methods that may be used to compare and to correlate attributes of individuals, objects or systems to determine a good match.

The Searching Methods that are described in this Specification may be embodied in software that is stored in the memory of one or more MateFinders, or may be incorporated in software that runs on a server that enables the operation of an Internet dating website. In general, the Searching Methods provided by the present invention may be used by a wide variety of devices or processes or to compute a distance, relationship or correlation between or among any individuals, objects or systems. The present invention provides a useful means for finding someone or something when the exact identity of the person or the object is not known, but desired attributes, characteristics or qualities of that person or object are known. In one specific implementation, the present invention may be used as an algorithm that enables a search engine to find a result based on a Distance Formula. When used in this Specification and in the Claims that follow, the term “Distance Formula” is intended to encompass any expression that enables the calculation of a distance or correlation between or among any two individuals, attributes, objects, systems or entities.

Distance as a Measure

In one embodiment of the invention, a matching algorithm that may be stored in the memory of a MateFinder is based on distance. The dimension of distance is already used in social contexts (“close friend,” “distant relative,” “She keeps her distance,” etc.) The formula for the distanced between two points (x₁,y₁) and (x₂,y₂) in the plane is:
d=\sqrt{(x₁−x₂)²+(y₁−y₂)²} Expression 1
The x coordinate of a point can be regarded as a measure of one attribute of the point, which we might call the horizontal attribute. Similarly, the y coordinate is a measure of the vertical attribute. The distance d is a joint measure of how well the attributes of the two points match, with smaller values indicating a better match. If d=0, the match is perfect because this happens if and only if the two points are exactly at the same place.

The two points can be labeled with any identification or name. For example, the point (x₁,y₁) might be “Fred” and the point (x₂,y₂) might be “Mary.” Similarly, each of the two attributes can be associated with any name, activity, pastime, belief or any other noun, subject or function. For example, the horizontal attribute might be labeled as “Golf” and the vertical attribute “Shopping.” If Fred is an avid golfer but hates to go shopping, his Golf attribute would have a large positive value, and his Shopping attribute would have a large negative value. If Fred and Mary are well matched in both attributes, the distance d between them will be small.

The distance formula can be generalized to permit any number of attributes to be considered. It is convenient to use a different symbolism for the attributes and their values. Suppose there are N attributes. Let F₁, F₂, . . . , F_{N} be Fred's values for attributes numbered 1, 2, . . . , N. Similarly, let M₁, M₂, . . . , M_{N} be Mary's values for those same attributes. The distance between Fred's and Mary's attribute constellations can be computed as

$$d ( F , M ) = \sqrt{{\sum }_{n = 1}^{N} {( {F}_{n} - {M}_{n} )}^{2}} \qquad Expression 2$$

Expression 2 has some possible shortcomings. First, the squaring operation puts more weight on attributes where the difference between Fred and Mary is large and less weight where the difference is small. Second, the range of values for each attribute has not been specified (Fred may think a large value for the Golf attribute is 10, but Mary might think it is 100). Third, if some attributes should be weighted more heavily than others, there is no provision for doing it.

All three shortcomings can be eliminated by changing the definition of distance. The new definition is a variation of the distance measure used by mathematicians in “taxicab geometry.” Taxicab geometry is used in a city with only north-south and east-west streets, where at any given moment a taxi can only be moving in one of the four directions and cannot travel the shortest possible distance to its destination as the crow flies, given by Expression 1. The new definition is:

$$d ( F , M ) = {\sum }_{n = 1}^{N} {w}_{n} \vert {F}_{n} - {M}_{n} \vert \qquad Expression 3$$

where | | denotes absolute value and wₙ is a number between 0 and 1 which assigns a weight to the nth attribute. The N weights have the property

$${\sum }_{n = 1}^{N} {w}_{n} = 1 \qquad Expression 4$$

which makes them relative weights. Also, the measure of each attribute Fn or Mn is also restricted to be a number between 0 and 1. Thus, if Fred plays golf very often, the value of his Golf attribute is 1, but if he does not play golf at all, it is 0.

With this definition, it is not hard to see that the distance d(F,M) will always be a number between 0 and 1, regardless of the number N of attributes or the assignment of weight values (The weights must sum to 1, however. Later we'll describe an easy way for this to be done automatically). Fred and Mary are well-matched or not well-matched according to whether the distance d(F,M) is close to 0 or close to 1. Of course, the thresholds for closeness must somehow be determined.

Applications of the Distance Formula

The distance formula given by Equation 3 can be used in a number of different ways:

### Example 1

### Matching What is Desired to What Exists

Suppose Fred is looking for a mate. For each of the N attributes, he enters a value desired in his mate and also assigns to that attribute a weight Wₙ between 0 and 1 (note that W is capitalized). A 1 means the attribute is very important to him, and 0 means it is not at all important. Fred does not have to worry about the sum of his weights being 1, because the relative weights wₙ, actually used will sum to 1. They will be computed by means of the formula

$${w}_{n} = \frac{{W}_{n}}{{\sum }_{k = 1}^{N} {W}_{k}} \qquad Expression 5$$

Meanwhile, Mary, being a potential mate, also assigns values to each of the attributes. Her values are chosen to characterize herself as best as she can. However, she doesn't concern herself with weights. That's Fred's job, at least for the moment.

The distance d from Fred's desires to Mary's attributes is computed by means of the formula given by Expression 3, permitting Fred to decide if Mary is a good match for him. To clarify how the formula is being used, we use the notation FDₙ for the Fred's desired value of the nth attribute (if he doesn't really care about that attribute, he can assign the weight Wₙ=0 to it), and we denote by MEₙ Mary's existing value for that same attribute. Thus, the distance formula becomes

$$d ( FD , ME ) = {\sum }_{n = 1}^{N} {w}_{n} \vert {FD}_{n} - {ME}_{n} \vert \qquad Expression 6$$

where d(FD,ME) denotes the distance from Fred's desired attribute constellation to Mary's existing constellation.

### Example 2

### Bidirectional Matching of Desires to What Exists

The above process can be reversed, with Mary matching her desired attribute values with Fred's existing values. This results in the distance d(MD,FE). It would seem to be a good omen if d(FD,ME) and d(MD,FE) were both small. A simple joint measure of a good match in both directions is obtained by using the formula

$${d}_{BDE} ( F , M ) = \frac{d ( FD , ME ) + d ( MD , FE )}{2} \qquad Expression 7$$

which is again a number between 0 and 1. The subscript letters in d_{BDE} mean bi-directional, desired-to-existing.

### Example 3

### Matching What Exists to What Exists

In this alternative embodiment, the weights might be predetermined by a psychologist whose education and experience provide a good basis for the weight values. Fred and Mary could each determine the values for their own attributes, or that might be better left in the hands of the psychologist by means of an interview or questionnaire. The distance between Fred and Mary would simply be determined by Expression 3.

### Example 4

### Handling “Must-Haves” and “Deal-Killers”

In matching what is desired to what exists (Example No. 1), Fred might want a good match to first be obtained using a specified subset R of the N attributes and no others. This is seamlessly accomplished as follows: Let the full set of attributes be called Set A. The elements of A are the positive integers from 1 to N, where N is the total number of attributes under consideration. Some of these attributes will only have the two allowable values 0 or 1, and we'll call them binary attributes. Examples of binary attributes might be “Homosexual” (1 for yes, 0 for no) or “A Smoker” (1 for yes, 0 for no). Let B denote the subset of binary attributes. This subset contains some, but not all, of the integers in A.

Fred's first step is to choose desired values FDₙ for all attributes (Set A). Of course, he is only allowed to choose 0 or 1 for the binary attributes, but for the others he may choose any number between 0 and 1. He then chooses a weight Wₙ for each attribute, and a decision threshold T between 0 and 1 for the matching process. Then Fred identifies which attributes are “must-have” attributes, which must constitute a Subset R of the Set B of binary attributes. The relative weights wₙ for all attributes are then computed as follows:

$${w}_{n} = \{ \begin{matrix} 1 & if n ∈ R \\ \frac{{W}_{n}}{{\sum }_{k ∈ A - R} {W}_{k}} & if n ∈ A - R\end{matrix} \qquad Expression 8$$

where the symbol ε means “is contained in,” and A-R denotes the set of attributes that are in A but not in R. When the weights wₙ determined by Equation 8 are used to compute the distance d(FD,ME) in Equation 6, the distance will be a number equal to or greater than 1 if the “must-have” attributes are not perfectly matched. In this case, Fred can decide not to proceed further. If the distance is less than 1, it can be compared with Fred's threshold T. If d(FD,ME)<T, a good match would be indicated.

### Example 5

### Changing the Attribute Scales

It might be desirable to have a different range of values for some or all of the attributes. The conversion is easily done. If the desired range of values for attribute number n is from a to b and the entered value x lies between these values, then the number y entered into the distance formulas would be

$$y = \frac{x - a}{b - a} \qquad Expression 9$$

which is a number between 0 and 1.

### Example 6

### Converting from Distance to “Correlation”

The formula
c(F,M)=1−d(F,M) Expression 10
can be used to convert the measure of a match from a distance to a “correlation,” which has the value 1 for a perfect match and 0 for the worst possible match.

### Example 7

### Measuring Dissimilarity in Genetic Attributes

For this application, the attributes can be the alleles associated with different genetic loci, with values of either 0 or 1. In some applications where genetic dissimilarity indicates a better match, the goal is reversed—the greater the distance between individuals, the better.

A Specific Implementation of the Invention

FIGS. 10, 11, 12 and 13 depict one particular implementation of the invention, and use the following terms, which are defined below. An “Actor” is a person, system or entity participating in the use of the Device, as defined below.

“Fred” is defined as the first-acting person or other entity. “Mary” is the second-acting entity. It is important to note that in this context, Fred and Mary may be of opposite or the same gender, and each may be of either gender, and either Fred or Mary or both may be non-living entities, objects, processes or systems.

“Attributes” in these drawings means tangible or intangible characteristics of the individual actors.

“Attribute Set A” is the set of all attributes used in the matching process. This set is the same for all actors. It is permissible for the actors to have different attribute sets. In this case, Attribute Set A is the intersection of the actors' attribute sets, that is, the set of attributes common to both actors.

“Value” is a description of the strength, degree, level, intensity, scope, scale, manifestation, propagation or perception of a particular Attribute. It may be a binary variable, such as gender, in which case it can only be “1” or “0,” (and is thus defined to be in Subset “B”), or it may be an analog variable, such as height, in which case it is selected from a scale which is known to all actors. For example, the actors might agree that a height Value of “1” should be assigned to heights of 7 feet or greater, while a height Value of “0” should be assigned to heights of 3 feet 6 inches or less, with Values for other heights linearly assigned to intermediate heights.

“Attribute Set B” is the subset of Attribute Set A consisting of all attributes which have binary values.

“Desired Attribute Value” is an Attribute which one actor wishes to find in an acceptable second actor.

“Existing Attribute Value” is an Attribute Value possessed by an actor.

“FDₙ” (Fred's Desired Value of Attribute n) is the nth member of a set of such Desired Attributes which has N members, and is given a Value as defined above. For example, Fred might prefer that Mary be about 6 feet tall, in which case he would assign a Value of 0.7 to his height Preference, FDₙ, where a specific value of n identifies the height attribute.

“FEₙ” is Fred's Value for a particular Existing Attribute, such as height. If he is 6 feet, 2 inches tall, the Value of his height Attribute FEₙ might be 0.762, where a specific value of n identifies the height attribute.

“Weight” is the relative importance of each Desired Attribute FDₙ. For example, height might of minor importance to Fred, in which case he (or the psychologist in Drawing 12), might assign that Desired Attribute a Weight of 0.3; however, body mass index (BMI) might be of great importance to Fred, in which case he or the psychologist might assign a Weight of 0.9 to his BMI preference, FDₙ, where a specific value of n identifies the BMI attribute. Certain Attributes, such as gender, might be non-negotiable, in which case they would be assigned a Weight of 1.

“Distance” is the overall weighted degree of match between Fred's Desired Attributes FD₁, . . . , FD_{N} and Mary's Existing Attributes ME₁, . . . , ME_{N}, or vice-versa, as calculated by Equation 6.

“Decision Threshold” is the maximum Distance at which an Actor or third party deems a match to be acceptable.

“Device” is a MateFinder, computer or other system. Each Actor may have a Device, or the Actors may share a Device, such as a server.

“Subset R” is a set of Desired Binary (Set B) Attributes, each of which, if not met, renders a match unattainable.

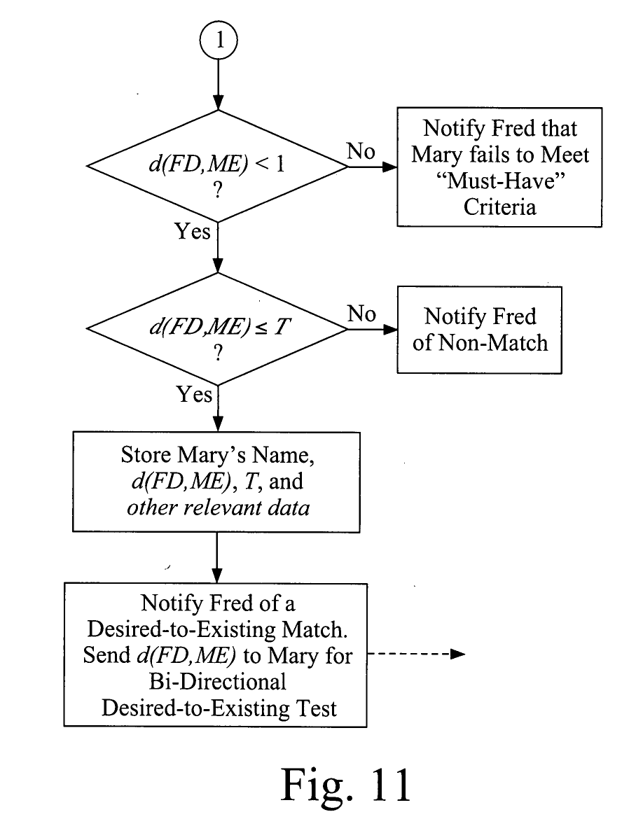

FIGS. 10 and 11 show the process by which Fred uses his Device to predict his compatibility with Mary, as follows:

1. Fred's Device has a list of A of N Attributes for which he must enter his desired Values. One by one, he enters a desired Value FDₙ for each of the Attributes in Set A into his Device.

2. Fred assigns a Weight Wₙ to each Attribute FDₙ.

3. Fred assigns a Value to his Decision Threshold T.

4. Fred selects a Subset R of binary Attribute Values in Subset B as defined above. Distances which are otherwise acceptable will be rendered unacceptable if these binary Attributes are not the same for both actors.

5. Fred's Device automatically computes a normalized Weight wₙ for each of Fred's desired Attributes FDₙ, using Expression 8.

6. At the same time, Mary has the same list A of Attributes. She enters a Value MEₙ for each Attribute corresponding to the degree to which she possesses that Attribute into her Device. These are then Mary's Existing Attribute Values.

7. Mary's Device then transmits Mary's Values MEₙ to Fred's Device.

8. Fred's Device then computes the Distance between Fred's desired Attributes FD₁, . . . , FD_{N} and Mary's existing Attributes ME₁, . . . , ME_{N}, using Expression 6.

9. Fred's Device then compares Mary's existing Values of Attributes in Fred's Subset R to Fred's desired values of attributes in Fred's Subset R. If any of Mary's Attribute Values conflict with the value of an Attribute in Fred's Subset R, Fred's Device notifies him that Mary fails to meet his criteria (alternatively, Fred's device may remain silent).

10. Fred's Device compares the Distance between Mary's existing Attribute Values and Fred's desired Attribute Values. If the Distance is longer than the Decision Threshold T that Fred has established, it may notify Fred that a match does not exist, or remain silent. Fred's Device then enters an idle mode.

11. If Fred's Device determines that the Distance between Mary's existing Attribute Values and Fred's desired Attribute Values is shorter than or equal to Fred's Decision Threshold T it then stores such identification as may be provided by Mary's Device, along with the Distance, Threshold and other relevant data, and proceeds to Step 12.

12. Fred's Device then sends its calculated Distance to Mary's Device. Mary may then opt to have her Device calculate a Distance based on her desired Attribute Values MDₙ and Fred's existing Attribute Values FEₙ, or take other action she deems appropriate.

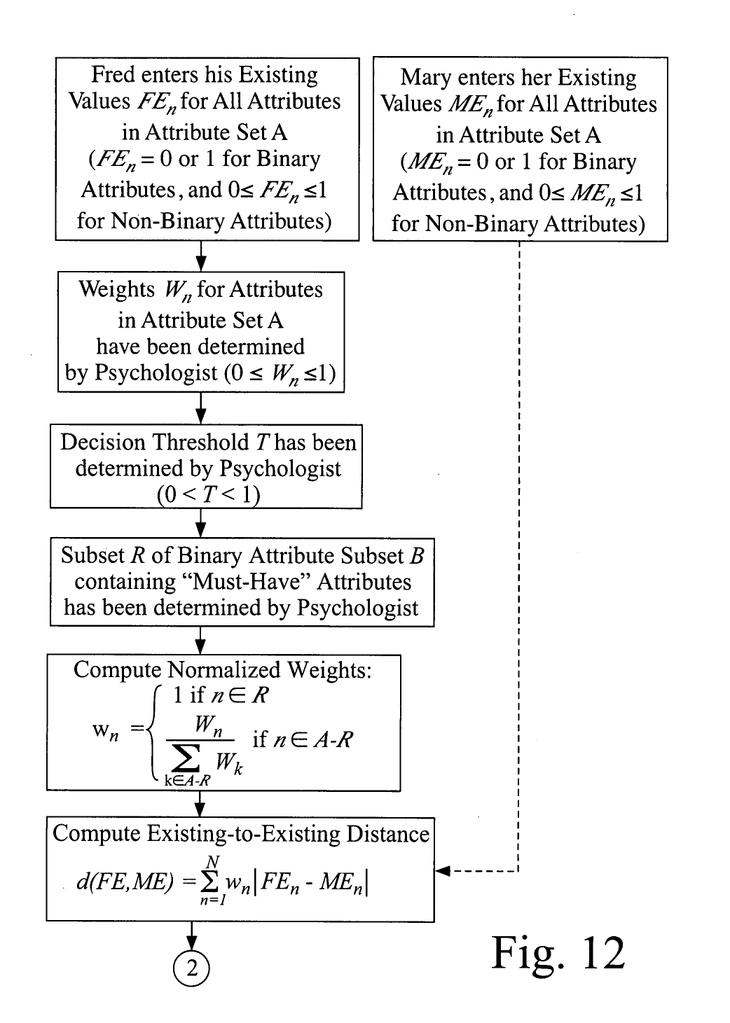

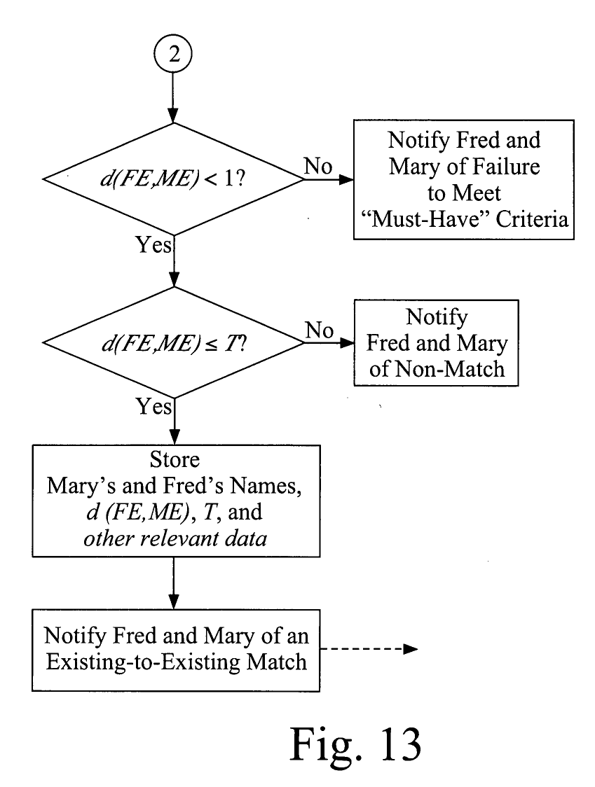

FIGS. 12 and 13 show the process by which Fred and Mary use the Device to compute their mutual compatibility, as follows:

1. Fred's and Mary's Devices have a list A of N Existing Attributes for which each must enter his or her Value. One by one, they enter a Value FEₙ and MEₙ for each of their Existing Attributes into their Devices or into a common system (hereafter Device in both cases).

2. A third party assigns a Weight Wₙ to each Attribute n.

3. A third party assigns a Value to the Decision Threshold T.

4. A third party selects a Subset R of the binary Attributes in Subset B as defined above. Distances which are otherwise acceptable will be rendered unacceptable if the value of the binary Attributes in R are not the same for both actors.

5. The Device or Devices automatically compute a normalized Weight wₙ for each of Fred's desired Attribute Values FDₙ, using Expression 8.

6. At the same time, Mary has the same list A of Attributes. She enters a Value MEₙ for each Attribute in Set A into her Device, which corresponds to the degree to which she possesses that Attribute.

7. Mary's Device then transmits Mary's Values MEₙ to Fred's Device.

8. Fred's Device then computes the Distance between Fred's Existing Attribute Values FE₁, . . . , FE_{N} and Mary's Existing Attribute Values ME₁, . . . , ME_{N}, using Equation 6, but with FD changed to FE and FDₙ changed to FEₙ.

9. Fred's Device then compares the values of Mary's Existing Attributes in Subset R to the existing Values of Attributes in to Fred's Subset R. If any of Mary's Attribute Values conflict with the value of an Attribute in Fred's Subset R, Fred's Device notifies Fred and notifies Mary's Device that they fail to meet matching criteria.

10. Fred's Device compares the Distance between Mary's existing Attribute Values and Fred's existing Attribute Values. If the Distance is greater than the Decision Threshold T, it notifies Fred and notifies Mary's Device that Fred and Mary fail to meet matching criteria.

11. If Fred's Device determines that the Distance between Mary's existing Attribute Values and Fred's existing Attribute Values is less than or equal to Fred's Decision Threshold T, it stores such identification as may be provided by Fred's and Mary's Devices, along with the Distance, Threshold and other relevant data.

12. Fred's and Mary's Device(s) then notify each of Fred and Mary of a satisfactory match.

### II. A Second Group of Embodiments

Using Searching Methods in an Internet Search Engine

In a second embodiment, the present invention is used to find information stored in a database, such as the Internet.

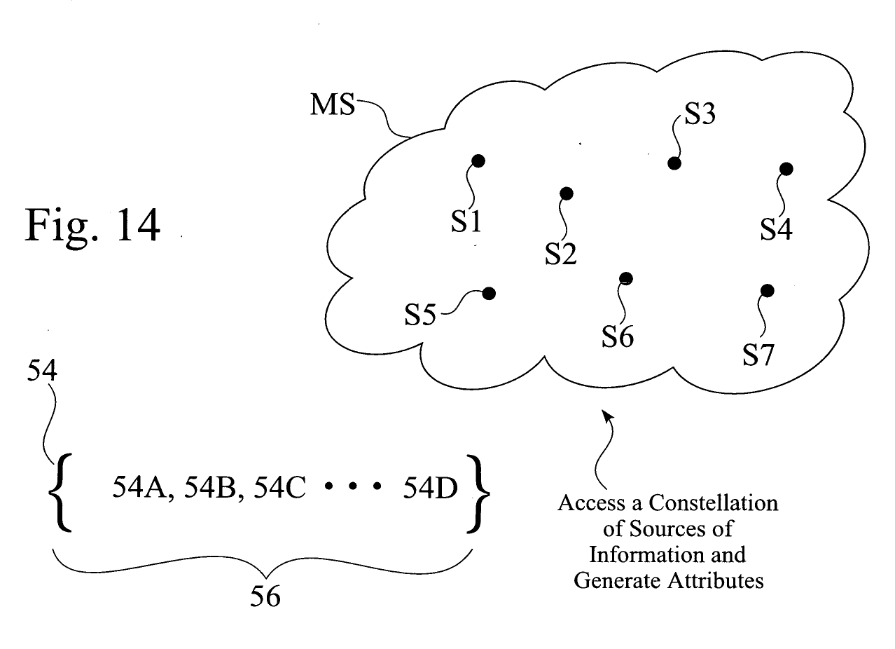

FIG. 14 is an abstract representation of a database or collection of information, such as the Internet. In this depiction, a number of webpages are characterized as sources of information (S₁, S₂, S₃, S₄, S₅, S₆, S₇, . . . , S_{N}), where N is the total number of webpages that may be accessed on the Internet. In a more general characterization, the entire set of webpages available on the Internet may be called the master set (MS) of sources of information.

When a search is conducted using a computer or some other electronic device to find a particular item of information that is available on the Internet, this search may be characterized as an attempt to find a target 56 within the master set MS. The target 56 is assumed to be one of the many sources of information (S₁, S₂, S₃, S₄, S₅, S₆, S₇, . . . , S_{N}) that populate the master set MS.

In accordance with the present invention, a distance formula search is performed by first selecting a set of attributes 54 which describe the target 56. In one embodiment of the invention, the formula for the distance d between two points (x₁,y₁) and (x₂,y₂) in the plane is:
d=\sqrt{(x₁−x₂)²+(y₁−y₂)²} Expression 1

The individual attributes that are selected are represented as 54A, 54B, 54C, 54D and so on. As an example, suppose the target of the search is a Red Delicious apple. One set of attributes that may be selected by the searcher are listed in Table Two:

TABLE TWO

Fruit
Red
Sweet
Ripe in autumn

In general, when the set of attributes is relatively large, the search results converge or are focused more quickly, and the “quality” of the search is higher. In general, if the set of attributes contains only one or two entries, the search is not effective. When the number of entries in the set of attributes equals or exceeds four, five or six, the search narrows the field of sources of information to more effectively locate the target 56.

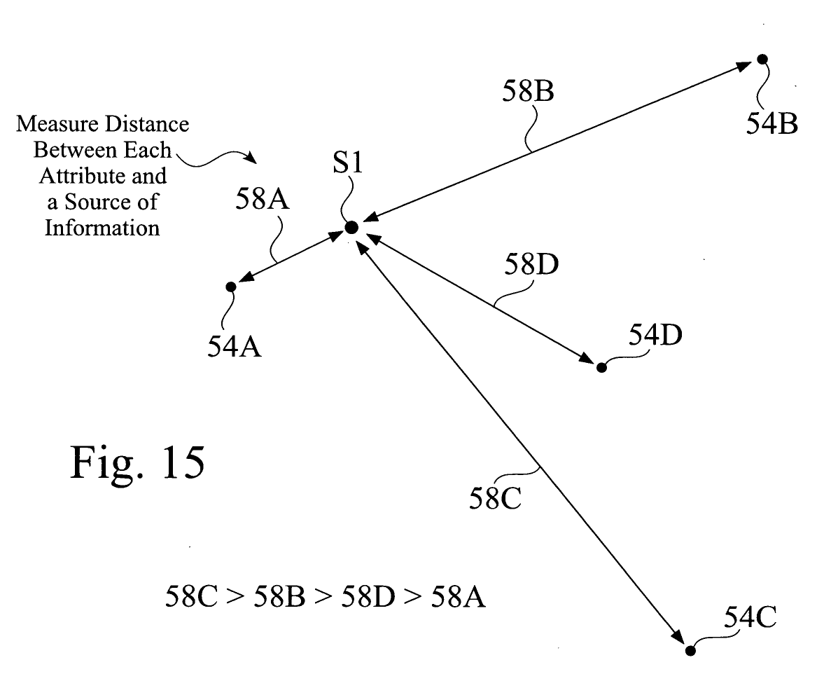

In accordance with the present invention, the sources of information in the master set MS and each of the selected attributes 54A, 54B, 54C and 54D may be graphically represented on a map, as shown in FIG. 15. In other words, from a mathematical point of view, all sources of information S and all conceivable attributes 54 occupy the same space. As a result, the distances between each attribute 54 and each source of information S may be measured to generate a “relevance distance.”

In one embodiment of the invention, a relevance distance 58 is defined as a level of correspondence, similarity or “closeness of identity” between an attribute 54 and a source of information S.

FIG. 15 shows how four relevance distances 58A, 58B, 58C and 58D are measured between pairs of attributes 54 and sources of information S. Distance 58A is the distance measured between attribute 54A and source S1. Distance 58B is the distance measured between attribute 54B and source S1. Distance 58C is the distance measured between attribute 54C and source S1. Distance 58D is the distance measured between attribute 54D and source S1.

In one embodiment of the invention, a distance is computed by comparing an attribute 54 to a source of information S. Returning to Table Two, the attribute “fruit” is compared to sources of information (S₁, S₂, S₃, S₄, S₅, S₆, S₇, . . . , S_{N}). All of the sources of information that contain the term “fruit” are deemed to be relevant, those that do not contain the term “fruit” are deemed to be irrelevant. Any sources that contain the term “fruit” twice are deemed to be twice as relevant as those which contain the term only once. Any sources that contain the term “fruit” three times are deemed to be three times as relevant as those which contain the term only once, and so on. In this way, the relevance of all the sources of information may be arranged in a list that proceeds from high to low relevance.

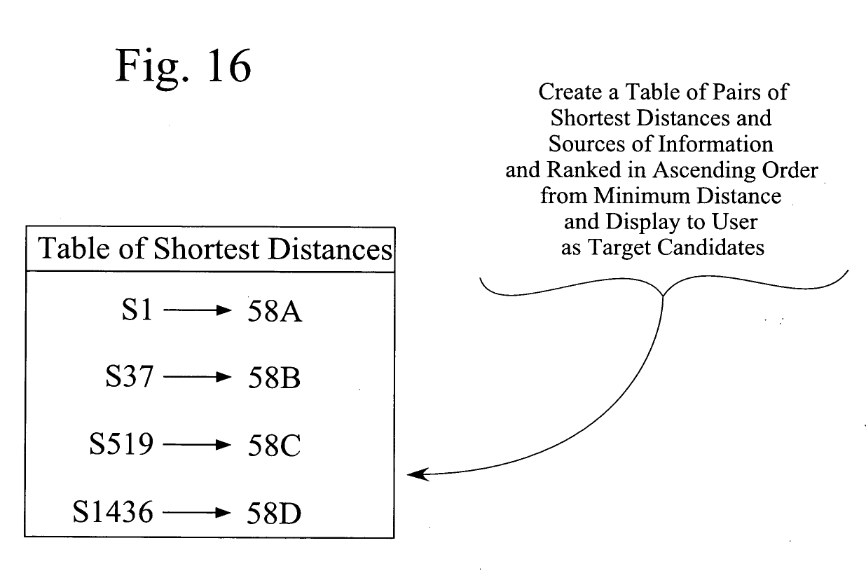

After each of the attributes 54 has been compared to the sources of information S, and the corresponding distances 58 have been measured, a Table of Shortest Distances is created by selecting the shortest distance that has been measured between one attribute and one source for each attribute. The shortest distance signifies the highest relevance. FIG. 16 portrays this table, which includes four entries: one for each selected attribute 54A, 54B, 54C and 54D. The table indicates that four hypothetical sources, S1, S37, S519 and S1436, are the most relevant sources of information that correspond to the four selected attributes.

If the total number of sources of information S in the master set MS is a very large number, the present invention includes an additional preconditioning step which reduces the amount of distance measuring that is required to complete a search. While the method depicted in FIGS. 14, 15 and 16 may be useful for a database of patient records in a physician's office, this method may be somewhat impractical when used as an Internet search engine.

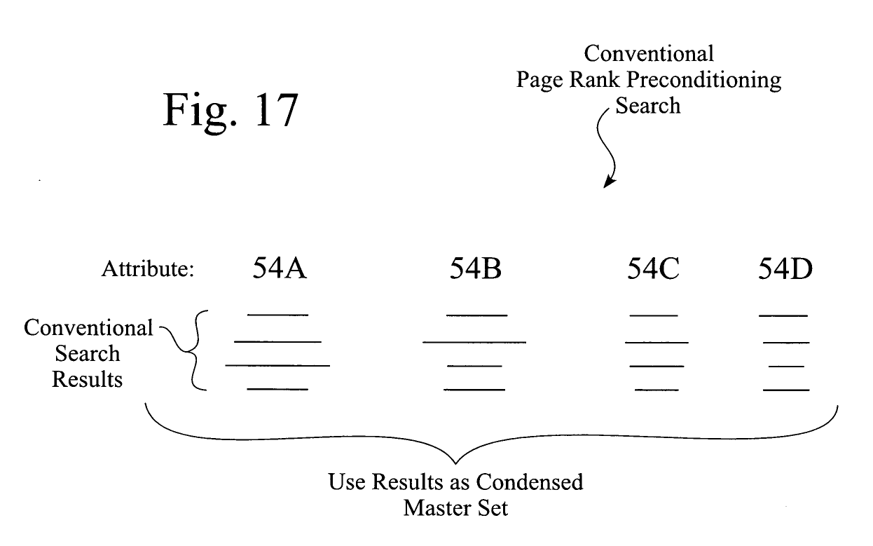

To improve the effectiveness of the method shown in FIGS. 14, 15 and 16, a conventional page rank search, such as the type of search that is offered by Google™, is first performed on each of the selected attributes 54, as shown in FIG. 17. The results of this set of preconditioning searches are then used as the master set MS. In virtually every instance, this results in a far smaller number of total sources that must be compared to attributes to create a set of shortest measured distances.

In this Specification and in the Claims that follow, the term “conventional search engine” refers to existing tools that are commonly available today on the Internet, such as those employed by Google™, Yahoo!® and Ask™. The term “plurality of sources of information” includes, but is not limited to, entries in a document or a number of documents, spreadsheet or database; one or more web pages; a record or recording which contains some form of written information, data, audio, video, signal or some other form of intelligence or pattern; and/or the address or some other information or data concerning a radio frequency identification device (RFID).

### III. A Third Group of Embodiments

More Advanced Searching Methods with Additional User Inputs & Controls

In a third embodiment, additional controls and inputs are provided for the user to obtain better search results.

### A. Creating an Initial Search Attributes List

In accordance with a third embodiment of the invention, a user creates an initial search attributes list which focuses on the target of the search. The term “target” is used to describe the information, data, graphics, photo, rendering, video, audio, representation or other sensible expression of intelligence that the user seeks to discover or obtain as a consequence of the search. In this description of the third embodiment, and in the Claims that follow, the word “attributes” includes keywords, but has broader scope, which facilitates searching for items whose name or identity is unknown. When used in this Specification and in the Claims that follow, the term “keyword” generally refers to an entry for a conventional search engine which attempts to specify the exact name of the target of a search. The terms “searcher” and “user” are generally equivalent in this description, and may comprise a person or some automated combination of software and/or hardware.

As an example of the third embodiment, suppose the target of the search is a device which allows a person to button the collar of a dress shirt, even if the collar is otherwise too small. The searcher does not know the precise product name or part number which the manufacturer or seller uses to identify this device.

Instead of trying to find this device using a keyword, the searcher enters a list of attributes:

TABLE THREE

shirt
collar
button
makes collar larger

These attributes may comprise single words or phrases. The attributes may also include numbers, graphics, photos, drawings or other forms of specification.

The list of search attributes is entered into a conventional search engine, and then produces the information shown in the following matrix:

$$\begin{matrix} & {S}_{1} & {S}_{2} & {S}_{3} & {S}_{4} & ⋯ & {S}_{N} & \\ {A}_{1} & {f}_{11} & {f}_{12} & {f}_{13} & {f}_{14} & ⋯ & & {f}_{1 N} \\ {A}_{2} & {f}_{21} & {f}_{22} & {f}_{23} & {f}_{24} & ⋯ & & {f}_{2 N} \\ {A}_{3} & {f}_{31} & {f}_{32} & {f}_{33} & {f}_{34} & ⋯ & & {f}_{3 N} \\ ⋮ & ⋮ & ⋮ & ⋮ & ⋮ & & ⋮ & \\ {A}_{M} & {f}_{M 1} & {f}_{M 2} & {f}_{M 3} & {f}_{M 4} & ⋯ & & {f}_{MN}\end{matrix} \qquad Expression ( 11 )$$

The first column (in boldface) in Expression 11 is the initial search attribute list, and the first row (in boldface) is a list of sources (i.e., “hits”) found by the conventional search engine that contain one or more attributes in the search attribute list. M is the number of attributes in the search attribute list, and is a reasonably small number (usually no more than 5 to 10, although it could be larger). N is the number of sources initially found by the search engine, and may be huge. For this reason, the matrix is not presented to the user. The entries fₘₙ in the matrix are the number of occurrences of the attribute Aₘ in the source Sₙ.

The search engine then ranks the sources according to relevance. There is an infinitude of ways this could be done. For the sake of concreteness, suppose that a relevance value Rₙ for each source is computed as follows:

$$\begin{matrix}{R}_{n} = relevance value for source {S}_{n} \\ = {W}_{n} {\sum }_{m = 1}^{M} {f}_{mn}\end{matrix} \qquad Expression ( 12 )$$

In this formula, Wₙ is a weight which is equal to the number of attributes in the search attribute list that appear at least once in source Sₙ. In other words, Wₙ is the number of nonzero terms in the summation appearing in Expression 12. The weighting by Wₙ is used because it seems that the larger the number of attributes appearing in a source, the more relevant that source is likely to be. If two sources each contain the same number of attributes (but not necessarily the same subset of attributes), they will receive the same weight, but could still have different values of relevance according to the size of the summation in Expression 12. The conventional search engine ranks the sources in accordance with the relevance values, with the sources having the larger values at the top of the list. Of course, it is possible (even likely) that some sources will have the same relevance values. When this happens, those sources could be sub-ranked within their relevance value according to some other criterion.

If it would be more satisfying to the user, the relevance values Rₙ could be converted into what might be called distances Dₙ by the inversion shown in Expression 13:

$${D}_{n} = \frac{1}{{R}_{n}} \qquad Expression ( 13 )$$

or by some other monotonically decreasing function of Rₙ. In this case, sources having smaller distances from the search attributes will be nearer the top of the source list.

### B. Interactive Search Refinement Using Linked Attributes

At this point, the user evaluates the initially found sources, starting at the top of the list, to determine if any meaningful search results have been found. In one implementation, the searcher utilizes linked attributes that the search engine locates in the sources which have been found. Linked attributes are defined as attributes within a source that are judged to be important by the search engine or the source, and are often unrelated to the user's search attributes. From each source that has been found, the search engine might select linked attributes based on thresholded frequency of occurrence in the source itself, on appearance within a list of attributes designed for the source, or on some other criterion. Of all the linked attributes that are discovered in all sources found, the search engine retains those which occur in more than a specified percentage P of the sources. Thus, a linked attribute list is created, which is presented to the user. Next to each linked attribute in this list is the number of sources in which it is found.

The linked attribute list is significant for two main reasons. First, it permits the user to quickly identify and eliminate a potentially large number of sources which are not relevant without having to examine a huge list of sources one source at a time. Secondly, it permits an expansion of the search to include sources that may be relevant, but which did not appear initially because the original attribute list created by the user was limiting the search too narrowly.

When the linked attribute list appears on the user's computer screen, the user can see at a glance attributes in addition to those he has chosen which can be used to sharpen his search, along with how many sources contain each linked attribute. With simple mouse clicks he can specify which of the linked attributes are non-relevant, so that the search engine can remove sources containing these attributes (hopefully a large number will be removed). Additionally, he can specify those linked attributes which he wants to add to his original search attribute list, allowing the search engine to find additional sources and do a re-ranking. When this is done, the additional linked attributes are added to his list of search attributes.

The above process of refining the search can be done as many times as desired. At all times during the search, two lists are being presented to the user—the current list of search attributes and an updated list of linked attributes.

### C. Method of the Third Embodiment

1. Initial Search: The user types in an initial search attribute list. This list is retained on the computer screen. The search engine extracts the information shown in the matrix (Expression 11) and finds N sources ranked according the relevance values or distances computed by (Expression 12) or (Expression 13) (it is convenient to think of the sources across the top of the matrix (Expression 11) as having been ranked in order of relevance).
2. Optional Source Inspection: If desired, the user may inspect the sources near the top of the currently ranked list to see if anything useful has appeared.
3. Creation of a Linked Attribute List: From the sources found so far, the search engine creates and presents a linked attribute list on the computer screen, located next to the user's list of search attributes. Next to each attribute in the list is the number of sources in which that attribute is found.
4. Selection of Non-Relevant Linked Attributes: The user identifies non-relevant linked attributes and clicks on a “DELETE” box next to each non-relevant linked attribute. The search engine excludes sources containing these attributes and the information in the matrix (Expression 11) changes to include only that which is extracted from the remaining sources (again it is convenient to think of the sources across the top of the matrix (Expression 11) as having been ranked in order of relevance).
5. Selection of Additional Search Attributes: The user can add additional search attributes to the search attribute list in two ways: He can simply add any attribute that comes to mind, or he can specify items in the linked attribute list which he wants to add to the search attribute list by clicking on an “ADD” box next to item he wishes to include. The selected linked attributes are added to the search attribute list appearing on the computer screen. In response, the search engine alters the sources in its source list, thus changing the matrix (Expression 11), and re-ranks the entire source list.
   At any time the user can inspect the sources found thus far. A good time for inspection is when the number of currently retained sources is small enough to permit inspection of the entire source list.

### D. An Example of the Third Embodiment

The following example describes an actual experience with a conventional Google™ search attempt to find information about current research on “multipath mitigation in GPS (Global Positioning System) receivers.” “Multipath” refers to the propagation of a signal from a GPS satellite which arrives at a GPS receiver, not only via the direct path, but also after being reflected from nearby objects. An accurate measurement of the arrival time of the direct path signals from several satellites is needed for the receiver to establish an accurate position. However, the arrival of reflected signals can cause significant errors. It is similar to the problem of understanding what is being said by a speaker in a large hall, such as a gymnasium, when echoes are present.

The searcher first types in the keywords “multipath” and “GPS,” and the computer responds as follows:

TABLE FOUR
23,033 Sources Found:

| Current Search | Linked | |
|---|---|---|
| Attributes | Attributes | No. of Sources |
| Multipath | GNSS | 541 |
| GPS | movies | 13,540 |
| | plot | 10,220 |
| | radar | 43 |
| | mitigation | 455 |
| | interactive | 6,050 |
| | sonar | 15 |
| | entertainment | 16,128 |
| | television | 8,269 |
| | computer gaming | 14,979 |

Looking over the list of linked attributes, it seems surprising that the attribute “multipath” and/or “GPS” appears quite often in sources that are rich in the linked attributes “movies,” “plot,” “interactive,” “entertainment,” “television,” and “computer gaming.”

In addition to its use in GPS, “multipath” is also a term describing video entertainment in which the viewer can interactively alter the course of a plot. To further confuse the situation, the use of GPS receivers is a common element in the entertainment provided by television dramas. The search is simply swamped by the alternative meaning of “multipath.”

The user then decides to delete sources linked with the linked attributes “movies,” “plot,” “interactive,” “entertainment,” “television,” and “computer gaming.” Each deletion is indicated by a D in the right hand decision column in Table 5 below. The user also realizes that “GNSS” is an attribute that should be added to my list of search attributes, because this term stands for “Global Navigation Satellite Systems,” a broader term which includes the GPS system, but also others. All such systems have the same problems with multipath signal propagation. The searcher then adds the search term “mitigation” to focus more tightly on information about the mitigation of multipath. Each addition is indicated by an A in the right hand decision column. The searcher retains the sources having linked attributes “radar” and “sonar” because he knows that such systems also have multipath problems that may be of interest.

TABLE FIVE
23,033 Sources Found:

| Current Search | Linked | | |
|---|---|---|---|
| Attributes | Attributes | No. of Sources | Decision |
| Multipath | GNSS | 541 | A |
| GPS | movies | 13,540 | D |
| | plot | 10,220 | D |
| | radar | 43 | |
| | mitigation | 455 | A |
| | interactive | 6,050 | D |
| | sonar | 15 | |
| | entertainment | 16,128 | D |
| | television | 8,269 | D |
| | computer gaming | 14,979 | D |

The computer now responds as follows:

TABLE SIX
230 Sources Found:

| Current Search | Linked | | |
|---|---|---|---|
| Attributes | Attributes | No. of Sources | Decision |
| Multipath | radar | 35 | |
| GNSS | sonar | 13 | |
| GPS | spatial | 72 | D |
| Mitigation | antenna | 40 | D |
| | maximum likelihood | 32 | |

The searcher now retains “radar” and “sonar” for the reasons cited previously. The new linked attributes “spatial,” “antenna,” “receiver,” “maximum likelihood,” and “signal processing” now appear. These items did not appear in the earlier linked attribute list because their frequency was significantly smaller than the attributes “movies,” “plot,” “interactive,” “entertainment,” “television,” and “computer gaming” which were previously deleted. However, after the sources containing these non-relevant attributes had been deleted, the new linked attributes occurred in a significantly larger percentage of the remaining sources, thus exceeding the percent threshold P. Consequently they now appear on the new linked attribute list.

The user now deletes the sources with linked attributes “spatial” and “antenna” as shown in Table 6 because these relate to multipath mitigation outside the receiver. The searcher is only interested in multipath mitigation techniques that use signal processing within the receiver. Therefore, he adds “signal processing” to the list of search attributes. Because the searcher knows that the linked attribute “maximum likelihood” is a mathematical method for multipath mitigation, this term is not added to the search attribute list in order to avoid too much limitation in the search. In addition, this term is not deleted, because doing so might remove some sources of interest.

The computer now responds with:

TABLE SEVEN
65 Sources Found:

| Current Search | Linked | | |
|---|---|---|---|
| Attributes | Attributes | No. of Sources | Decision |
| Multipath | radar | 35 | |
| GNSS | sonar | 13 | |
| GPS | maximum likelihood | 32 | |
| mitigation | correlation | 22 | |
| signal processing | | | |

At this point the searcher judges the number of found sources to be small enough for individual examination. Furthermore, the new linked attribute “correlation” is a good omen, because the searcher knows that it is strongly related to multipath mitigation by certain signal processing methods.

### E. Alternative Embodiments

Additional features which may be added to this third embodiment include, but are not limited to, the following:
1. The percentage threshold P for screening linked attributes can be made variable, even interactively changeable by the user as he proceeds through the search.
2. The user's computer may be configured to maintain a log of the entire search session, permitting the user to backtrack and change his inputs at any stage, or optionally to store the log as a file if he might want to reinstate the search at a later time.
3. Boolean logic such as “AND” and “OR” can be used in the search attribute list. For example, the searcher might have started the search with a single entry “GPS & multipath” in the search attribute list, which probably would have reduced the number of non-relevant sources citing multipath in connection with entertainment.
4. Case sensitivity or non-sensitivity may be incorporated into the search.
5. Other filters, such as numerical ranges for dates, sizes, weights or power may be used in conjunction with the search.

### F. Comparisons to a Conventional Search Engines

The third embodiment of the invention offers the following advantages when compared to conventional search engines:
1. The user is provided with an efficient and interactive means of deleting, as well as adding, attributes used in the search without having to re-initiate the search.
2. At all stages of the search the user is kept informed of the effects of his attribute add/delete decisions by being able to view the linked attribute list and the number of sources associated with each linked attribute in the list.
3. At any time during a search the user can change the threshold P for the percentage of sources in which a linked attribute is found. The linked attribute is retained in the attribute list if and only if this threshold is exceeded.
4. A log of the entire search is continuously maintained, which includes a history of all attributes entered and deleted, and all results of the search at each stage. At any time the user can backtrack to any previous point in the search and modify his additions or deletions of attributes.

### G. A Fourth Embodiment

In a fourth embodiment, the matching algorithm comprises three steps:

encoding (mapping customer inputs to a vector space);

pairwise metric evaluation (computing metric between customers vector and vectors of other customers in area); and

decoding (mapping of metric value to customer usable format).

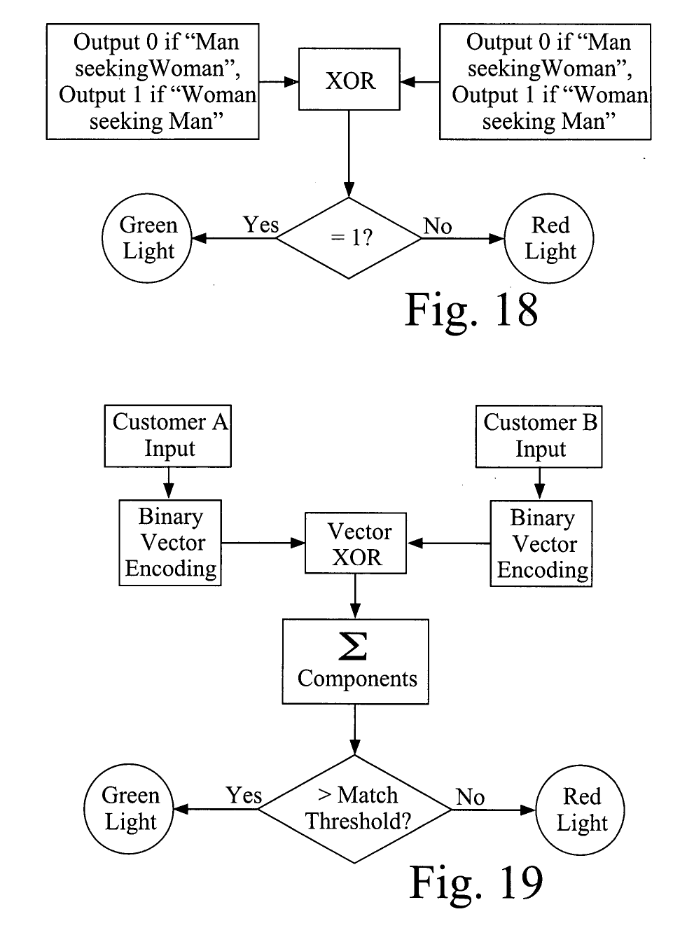

The encoding could be as simple as mapping “man seeking woman” to zero (0) and “woman seeking man” to one (1). Then the metric could be as simple as an exclusive or (XOR) operation. The truth table for XOR is 0 XOR 0=0, 0 XOR 1=1, 1 XOR 0=1, and 1 XOR 1=0. Then the decoding could be as simple as mapping 1 to a green light and mapping 0 to a red light, as shown in FIG. 18.

In the most general case, the vectors may comprise an ordered list of N values, and each value can be from a different set. For example, consider N=2 and the set for the first position is {0, 1, 2, 3, 4}, and the set for the second position is {Yes, No}. {Then 3, Yes} is a possible vector. In practice, we can restrict ourselves to an N-dimensional vector space over some field. We can encode any ordered list of N values into a vector in such a space with appropriate choice of underlying field. The encoded vector is preferable to an ordered list of values when computing metrics.

Possible fields include Z₂={0, 1}, Z_{P}={0, 1, 2, . . . , P−1} where P is a prime, Q (the rational numbers), R (the real numbers), and C (the complex numbers).

Another alternative, which is shown in FIG. 19, is binary encoding, Z₂, and sum of XOR as the pairwise metric to facilitate implementation in logic gates. The simplest pairwise vector metric would be the sum of component-wise XORs, assuming binary encoding:

$$Metric = {\sum }_{k = 0}^{N - 1} {a}_{k} ⊗ {b}_{k} \qquad Expression ( 14 )$$

where a=(a₀, a₁, . . . , a_{N-1}) is the vector for one customer and b=(b₀, b₁, . . . , b_{N-1}} is the vector for another customer.
Other possible metrics include:
a) sum of absolute values of component-wise differences:

$$Metric = {\sum }_{k = 0}^{N - 1} \vert {a}_{k} - {b}_{k} \vert \qquad Expression ( 15 )$$
b) sum of squares of component-wise differences:

$$Metric = {\sum }_{k = 0}^{N - 1} {( {a}_{k} - {b}_{k} )}^{2} \qquad Expression ( 16 )$$
c) sum of some other power (could be positive or negative, could be integer or real) of component-wise differences:

$$Metric = {\sum }_{k = 0}^{N - 1} {( {a}_{k} - {b}_{k} )}^{β} \qquad Expression ( 17 )$$
d) sum of component-wise products (dot product):

$$Metric = {\sum }_{k = 0}^{N - 1} {a}_{k} {b}_{k} \qquad Expression ( 18 )$$
e) sum of logarithms of absolute values of component-wise differences:

$$Metric = {\sum }_{k = 0}^{N - 1} log ( \vert {a}_{k} - {b}_{k} \vert \text{)} \qquad Expression ( 19 )$$
f) sum of some other function of component-wise differences:

$$Metric = {\sum }_{k = 0}^{N - 1} f ( {a}_{k} - {b}_{k} ) \qquad Expression ( 20 )$$

The above metrics can be weighted using a weight vector which is component-wise multiplied by each component-wise difference, or component-wise product, prior to the summation. For example with the component-wise products metric:

$$Metric = {\sum }_{k = 0}^{N - 1} {w}_{k} {a}_{k} {b}_{k} \qquad Expression ( 21 )$$

where w=(w₀, w₀, . . . , w₀) is the weight vector.
Another weighting method is to use an N×N weighting matrix, where N is the dimension of the encoded vector space. The weighting matrix is multiplied by the transpose of the customer's vector and the other customers' vectors are multiplied by the resulting vector to form a scalar:
Metric=a^{T}Wb Expression (22)
where W is the weighting matrix and the boldfaced T denotes matrix transpose.
The decoding can be a map into anything customer friendly. For example, a “match score”, say from 1 to 10. Another example is “match/no match”, displayed with lights, colors, or the words themselves.
Matching can be made adaptive in two ways. In the first method, the encoded vector is adapted (changed) based on customer feedback on prior matches. In the second method, the weighting vector, or weighting matrix, is adapted (changed) based on customer feedback on prior matches. Both methods could be used simultaneously. The feedback could be binary—“I liked the match” or “I did not like the match”. Another possibility is a numerical value, say 1 to 10 with 10 being a great match and 1 being a very poor match. Still another possibility would be multi-characteristic feedback, such as a rating form.

### H. A Fifth Embodiment

### A Website for Finding Generic Products

In yet another implementation of the invention, the Applicants' Searching Methods may be used to find a generic part or product when the searcher does not know the name of the part or the appropriate manufacturer's part number. As an example, suppose a person needs a replacement part for an appliance or automobile, but does not have a part number. The present invention may be used to find the correct replacement part by performing a search that employs a set of attributes that describe the needed part or product. The search may find a generic part which is priced far lower than the equivalent part that originates with the original manufacturer. This fourth embodiment may also be used to find generic drugs, medications or other medicinal preparations.

As a particular example, suppose a person wants to purchase a device which wirelessly transmits both the audio and video portions of a television signal from a first television in one room to a second television in another room in his house. This person is vaguely aware that such a device is available for sale, but does not know the manufacturer or the name that the manufacturer uses to identify this product.

If this person uses a conventional search engine such as Google™, he must rely upon keywords, such as: television, wireless, transmitter, and in-home. When used in a conventional search engine, this particular set of keywords does not produce results that are especially helpful, because none of these keywords match the name that the manufacturer uses to describe the sought after device.

If, on the other hand, the searcher were able to conduct a search using these same keywords as attributes using the Applicants' Searching Methods, the present invention would identify several products that are currently available for sale and that are identified as “Video Senders.”

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives for providing Searching Methods that have been disclosed above are intended to educate the reader about preferred embodiments of the invention, and are not intended to constrain the limits of the invention or the scope of Claims.

### LIST OF REFERENCE CHARACTERS

| | |
|---|---|
| 10 | MateFinder ™ |
| 10a | First user's MateFinder |
| 10b | Second user's MateFinder |
| 11 | Interrogation or seeking signal |
| 11a | First interrogation signal |
| 11b | Second interrogation signal |
| 12 | Housing |
| 14 | Power switch |
| 15 | “Seeking” indicator light |
| 16 | “Match Found” indicator light |
| 16a | First match indicator |
| 16b | Second match indicator |
| 17a | Man |
| 17b | Woman |
| 18 | LCD message screen |
| 19 | Website |
| 20 | USB port |
| 22 | Personal computer |
| 24 | USB cable |
| 26 | Battery |
| 28 | Radio/Processor assembly |
| 30 | Antenna |
| 32 | Memory |
| 32a | First memory |
| 32b | Second memory |
| 33 | Attribute |
| 33a | First set of attributes |
| 33b | Second set of attributes |
| 34 | Mask switch |
| 35 | Correlation thumbwheel |
| 36 | Microprocessor |
| 37 | Local wireless network |
| 38 | Downconverter |
| 39 | Transmit/Receive Switch |
| 40 | Amplifier |
| 42 | Modulator |
| 44 | Upconverter |
| 46 | Amplifier |
| 48 | Bandpass filter |
| 49 | MateFinder with Cellular Telephone Combination |
| 50 | Wireless network |
| 51 | Wireless signals to and from network |
| 52 | Network radio |
| 54 | Attribute |
| 56 | Target |
| 58 | Relevance distances |

### LIST OF VARIABLES USED IN MATHEMATICAL EXPRESSIONS

Symbols in Mathematical Expressions from the First Group of Embodiments:

| | |
|---|---|
| d | distance |
| (x₁, y₁) | coordinates of a first point in the plane |
| (x₂, y₂) | coordinates of a second point in the plane |
| n or k | an index which identifies an attribute, a weight, or an |
| | information source |
| N | the number of attributes or weights under consideration |
| | (Expressions 1-10) |
| F | Fred |
| M | Mary |
| Fₙ | The value of Fred's n^{th} attribute |
| Mₙ | The value of Mary's n^{th} attribute |
| wₙ | Relative weight for an n^{th} attribute (sum of all such weights is |
| | 1) |
| Wₙ | Weight for an n^{th} attribute before converting to a relative weight |
| FD | The set of attributes which Fred desires in a mate |
| FDₙ | The n^{th} attribute in the set of attributes Fred desires in a mate |
| FE | The set of attributes which Fred possesses |
| MD | The set of attributes which Mary desires in a mate |
| ME | The set of attributes which Mary possesses |
| MEₙ | The n^{th} attribute in the set of attributes which Mary possesses |
| d_{BDE} | Bidirectional distance, desired-to-existing attributes |
| ∈ | Symbol for “is contained in” |
| A-R | The set of attributes that are in set A but not in set R |
| T | Threshold for deciding if there is a match |
| a, b | Lower and upper limits for the range of an attribute value |
| x, y | The original and converted attribute values in Expression 9 |
| c | Correlation between two sets of attributes |

Symbols in Mathematical Expressions from the Third Group of Embodiments:

| | |
|---|---|
| M | The number of attributes under consideration in a search |
| N | The number of sources found in a search |
| m | An index which identifies a search attribute |
| n | An index which identifies a source found in a search |
| fₘₙ | The number of occurrences of the attribute Aₘ in the source Sₙ |
| Rₙ | Relevance value for source Sₙ |
| Wₙ | Weight used in calculating Rₙ |
| Dₙ | Distance from n^{th} source to the set of search attributes |

Symbols in Mathematical Expressions from the Fourth Embodiment:

| | |
|---|---|
| N | The number of elements (components) within a customer's |
| | vector |
| k | An index which identifies an element (component) within a |
| | customer's vector |
| aₖ and bₖ | The values of the k^{th} element (component) of vector a for one |
| | customer and vector b for the other customer |
| β | An exponent (power) used in Expression (17), which is a |
| | positive real number |
| wₖ | A weight which can be used with Expressions (14)-(20), as |
| | exemplified in Expression (21) |
| a^{T} | The transpose of vector a |
| W | A weighting matrix used in Expression (22) |

What is claimed is:

1. An apparatus comprising:
a first transceiver (10a);
said first transceiver (10a) including a first memory (32a); said first memory (32a) for storing a first attribute (33a) selected by a first user (17a);
said first transceiver (10a) including a first match indicator (16a);
a second transceiver (10b);
said second transceiver (10b) including a second memory (32b); said second memory (32b) for storing a second attribute (33b) selected by a second user (17b);
said second transceiver (10b) including a second match indicator (16b);
said first transceiver (10a) for emitting a first interrogation signal (110);
said first interrogation signal (110) being received by said second transceiver (10b);
said first match indicator (16a) on said first transceiver (10a) being activated when said first interrogation signal (110) finds a match between said first attribute set (33a) stored in said first memory (32a) in said first transceiver (10a) and said second attribute set (33b) stored in said second memory (32b) in said second transceiver (10b);
a wireless network (50);
a first network radio (52a); said first network radio (52a) being co-located with said first transceiver (10a); said first network radio (52a) being used to communicate over said wireless network (50); and
said match being determined using a distance formula.

2. An apparatus as recited in claim 1, in which said distance formula is used to correlate said first attribute set (33a) and said second attribute set (33b).

3. An apparatus as recited in claim 1, in which said distance formula is stored in said first and said second memory (32a, 32b).

4. An apparatus as recited in claim 1, in which said distance formula is incorporated in software that runs on a server that enables the operation of an Internet dating website.

5. An apparatus as recited in claim 1, in which a correlation between said first and said second attribute sets (33a, 33b) may be computed using the expression
$$d ( F , M ) = \sqrt{{\sum }_{n = 1}^{N} {( {F}_{n} - {M}_{n} )}^{2}}$$
where an individual possessing the first set of attributes is identified as F;
an individual possessing the second set of attributes (x₂,y₂) is identified as M;
d(F, M) is a distance between F and M;
N is a number of attributes;
F₁, F₂, . . . , F_{N} represent a plurality of attribute values for F; and
M₁, M₂, . . . , M_{N} represent a plurality of attribute values for M.

6. An apparatus as recited in claim 1, in which a correlation between said first and said second attribute (33a, 33b) may be computed using the expression
$$d ( F , M ) = {\sum }_{n = 1}^{N} {w}_{n} \vert {F}_{n} - {M}_{n} \vert$$
where | | denotes absolute value; and
wₙ is a number between 0 and 1 which assigns a weight to an nth attribute.

7. An apparatus as recited in claim 6, in which a value for a relative weight is computed using the expression:
$${w}_{n} = \frac{{W}_{n}}{{\sum }_{k = 1}^{N} {W}_{k}}$$
where Wₙ is an initially chosen weight for the n^{th} attribute.

8. An apparatus as recited in claim 1, in which a distance from a first desired attribute set to a second existing attribute set is computed using the expression:
$$d ( FD , ME ) = {\sum }_{n = 1}^{N} {w}_{n} \vert {FD}_{n} - {ME}_{n} \vert$$
where FD is a desired attribute set of a first individual; and
ME is an existing attribute set of a second individual.

9. An apparatus as recited in claim 1, in which a bidirectional match may be computed using the expression
$${d}_{BDE} ( F , M ) = \frac{d ( FD , ME ) + d ( MD , FE )}{2}$$
where FD is a desired attribute of a first individual;
ME is an existing attribute of a second individual;
MD is a desired attribute of said second individual; and
FE is an existing attribute of said first individual.

10. An apparatus as recited in claim 1, in which a relative weight wₙ for all attributes may be computed using the expression:
$${w}_{n} = \{ \begin{matrix} 1 & if n ∈ R \\ \frac{{W}_{n}}{{\sum }_{k ∈ A - R} {W}_{k}} & if n ∈ A - R\end{matrix}$$
Where ε means “is contained in”; and
A-R denotes a set of attributes that are in A but not in R.

11. An apparatus as recited in claim 1, in which said distance is converted to a correlation using the expression
c(F,M)=1−d(F,M).

12. A method comprising the steps of:
providing a device (10); said device (10) including a memory (32) and a radio (28);
storing a distance formula in said memory (32);
storing an attribute in said memory (32); and
using said device (10) to find a good match based on a correlation produced by said distance formula.

13. A method as recited in claim 12, in which said distance formula is used to correlate said first attribute (33a) and said second attribute (33b).

14. A method as recited in claim 12, in which said distance formula is stored in said first and said second memory (32a, 32b).

15. A method as recited in claim 12, in which said distance formula is incorporated in software that runs on a server that enables the operation of an Internet dating website.

16. A method as recited in claim 2, in which a correlation between said first and said second attribute sets (33a, 33b) may be computed using the expression
$$d ( F , M ) = \sqrt{{\sum }_{n = 1}^{N} {( {F}_{n} - {M}_{n} )}^{2}}$$
where an individual possessing the first set of attributes is identified as F;
an individual possessing the second set of attributes (x₂,y₂) is identified as M;
d(F, M) is a distance between F and M;
N is a number of attributes;
F₁, F₂, . . . , F_{N} represent a plurality of attribute values for F; and
M₁, M₂, . . . , M_{N} represent a plurality of attribute values for M.

17. A method as recited in claim 12, in which a correlation between said first and said second attribute sets (33a, 33b) may be computed using the expression
$$d ( F , M ) = {\sum }_{n = 1}^{N} {w}_{n} \vert {F}_{n} - {M}_{n} \vert$$
where | | denotes absolute value; and
wₙ is a number between 0 and 1 which assigns a weight to an nth attribute.

18. A method as recited in claim 17, in which a value for a relative weight is computed using the expression:
$${w}_{n} = \frac{{W}_{n}}{{\sum }_{k = 1}^{N} {W}_{k}}$$
where Wₙ is an initially chosen weight for the n^{th} attribute.

19. A method as recited in claim 12, in which a distance from a first desired attribute set to a second existing attribute set is computed using the expression:
$$d ( FD , ME ) = {\sum }_{n = 1}^{N} {w}_{n} \vert {FD}_{n} - {ME}_{n} \vert$$
where FD is a desired attribute of a first individual; and
ME is an existing attribute of a second individual.

20. A method as recited in claim 12, in which a bidirectional match may be computed using the expression
$${d}_{BDE} ( F , M ) = \frac{d ( FD , ME ) + d ( MD , FE )}{2}$$
where FD is a desired attribute of a first individual;
ME is an existing attribute of a second individual;
MD is a desired attribute of said second individual; and
FE is an existing attribute of said first individual.

21. A method as recited in claim 12, in which a relative weight wₙ for all attributes may be computed using the expression:
$${w}_{n} = \{ \begin{matrix} 1 & if n ∈ R \\ \frac{{W}_{n}}{{\sum }_{k ∈ A - R} {W}_{k}} & if n ∈ A - R\end{matrix}$$
Where ε means “is contained in”; and
A-R denotes a set of attributes that are in A but not in R.

22. A method as recited in claim 12, in which said distance is converted to a correlation using the expression
c(F,M)=1−d(F,M)

23. A method comprising the steps of:
accessing a master set (MS); said master set (MS) including a plurality of sources of information (S1; S2, S3, S4, S5, S6, S7, . . . S{N});
generating a set of attributes (54); said set of attributes (54) including a plurality of individual attributes (54A, 54B, 54C . . . 54D) and collectively describing a target (56);
providing a distance formula (Expression 1);
computing a set of relevance distances (58); said set of relevance distances (58) including a plurality of individual distances (58A, 58B, 58C, 58D) between each of said individual attributes (54A, 54B, 54C . . . 54D) and said plurality of sources of information (S1; S2, S3, S4, S5, S6, S7, . . . S{N});
selecting a subset of sources of information (S1′, S2′, S3′); and
ranking said subset of sources of information (S1′, S2′, S3′) in the general order of shortest relevance distances (58) measured between said subset of sources of information and said set of attributes (54).

24. A method as recited in claim 23, further comprising the step of:
performing a page rank search plurality of individual attributes (54A, 54B, 54C . . . 54D) to reduce the total number of sources of information (S1; S2, S3, S4, S5, S6, S7, . . . S{N}) prior to using said distance formula (Exp. 1) to measure said relevance distances (58).

25. A method as recited in claim 23, in which said plurality of sources of information includes a web page.

26. A method as recited in claim 23, in which said plurality of sources of information includes a record.

27. A method as recited in claim 23, in which said plurality of sources of information includes a document.

28. A method as recited in claim 23, in which said plurality of sources of information includes an address of an RFID device.

29. A method as recited in claim 23, in which the method step of ranking said subset of sources of information (S1′, S2′, S3′) in the general order of shortest relevance distances (58) measured between said subset of sources of information and said set of attributes (54) is used to create a website for finding generic products.

30. A method as recited in claim 23, in which the method step of ranking said subset of sources of information (S1′, S2′, S3′) in the general order of shortest relevance distances (58) measured between said subset of sources of information and said set of attributes (54) is used to create a website for finding a replacement part.

31. A method of searching for a match comprising the steps of:
providing a first set (F,MS) of data identifiers (Fₙ,SI);
generating a second set of user-selected data identifiers (Mₙ,54) relating to a target (M,56);
computing a set of relevance distances (58) comprising a plurality of individual distances (58A-D) between respective data identifiers of the first and second sets;
providing a distance formula which is a function which combines the plurality of individual distances; and
applying the formula to determine an overall degree of match.

32. A method according to claim 31, wherein weighting factors Wₙ are assigned to the identifiers.

33. A method according to claim 31, wherein the data identifiers (Fₙ) of the first set relate to a first entity (F) and the data identifiers (Mₙ) of the second set relate to a second entity (M), whereby the formula determines an overall degree of match between the entities.

34. A method according to claim 33, wherein the distance formula provided is:
$$d ( F , M ) = \sqrt{{\sum }_{n = 1}^{N} {( {F}_{n} - {M}_{n} )}^{2}}$$
where an entity possessing the first set of attributes is identified as F;
an entity possessing the second set of attributes is identified as M;
d(F, M) is a distance between F and M;
N is a number of attributes;
F₁, F₂, . . . , F_{N} represent a plurality of attribute values for F; and
M₁, M₂, . . . , M_{N} represent a plurality of attribute values for M.

35. A method according to claim 34, wherein the distance formula provided is:
$$d ( F , M ) = {\sum }_{n = 1}^{N} {w}_{n} \vert {F}_{n} - {M}_{n} \vert$$
where an entity possessing the first set of attributes is identified as F;
an entity possessing the second set of attributes is identified as M;
d(F, M) is a distance between F and M;
N is a number of attributes;
F₁, F₂, . . . , F_{N} represent a plurality of attribute values for F; M₁, M₂ . . . Mₙ represent a plurality of attribute values for M;

| | denotes absolute value; and
wₙ is a number between 0 and 1 which assigns a weight to an nth attribute.

36. A method according to claim 35, in which a value for a relative weight is computed using the expression:
$${w}_{n} = \frac{{W}_{n}}{{\sum }_{k = 1}^{N} {W}_{k}}$$
where Wₙ is an initially chosen weight for the n^{th} attribute.

37. A method according to claim 33, wherein a distance from a first desired attribute set to a second existing attribute set is computed using the expression:
$$d ( FD , ME ) = {\sum }_{n = 1}^{N} {w}_{n} \vert {FD}_{n} - {ME}_{n} \vert$$
where FD is a desired attribute set of a first individual;
ME is an existing attribute set of a second individual;

| | denotes absolute value; and
wₙ is a number between 0 and 1 which assigns a weight to an nth attribute.

38. A method according to claim 32, wherein a bidirectional match is computed using the expression:
$${d}_{BDE} ( F , M ) = \frac{d ( FD , ME ) + d ( MD , FE )}{2}$$
where FD is a desired attribute of a first individual;
ME is an existing attribute of a second individual;
MD is a desired attribute of said second individual; and
FE is an existing attribute of said first individual.

39. A method according to claim 33, wherein a relative weight wₙ for all attributes is computed using the expression:
$${w}_{n} = \{ \begin{matrix} 1 & if n ∈ R \\ \frac{{W}_{n}}{{\sum }_{k ∈ A - R} {W}_{k}} & if n ∈ A - R\end{matrix}$$
where ε means “is contained in”; and
A-R denotes a set of attributes that are in A but not in R.

40. A method according to claim 33, wherein the distance is converted to a correlation using the expression
c(F,M)=1−d(F,M).

41. A method according to claim 31, wherein the data, identifiers of the first set are sources of information (S1-S{N}) of a master set (MS) and the data identifiers of the second set are individual attributes (54A-54D) collectively describing the target (56), and wherein the relevance distances (58) computed in the computing step comprise a plurality of individual distances (58A, 58B, 58C, 58D) between each of said individual attributes (54A, 54B, 54C . . . 54D) and said plurality of sources of information (S1; S2, S3, S4, S5, S6, S7, . . . S{N}).

42. A method according to claim 41, further comprising the steps of:
selecting a subset of the sources of information (S1′, S2′, S3′) in the general order of shortest relevance distances (58) measured between said subset of sources of information and said set of attributes (54).

43. A method according to claim 41, further comprising the step of:
performing a page rank search plurality of individual attributes (54A, 54B, 54C . . . 54D) to reduce the total number of sources of information (S1; S2, S3, S4, S5, S6, S7, . . . S{N}) prior to applying the distance formula to measure said relevance distances (58).

44. A method according to claim 40, further comprising the steps of:
identifying non-relevant linked attributes; and
excluding from the search sources of information containing said non-relevant linked attributes.

45. A method according to claim 31, wherein the at least one sources of information include a web page.

46. A method according to claim 31, wherein the sets of data identifiers are encoded into respective vectors and the computing step and the subsequent steps comprise:
evaluation of the metric between each vector and other vectors; and
decoding the metric.

47. A method according to claim 46, wherein the metric used is a sum of N components, where N is the dimension of the encoded vector space, each component being a specific function of a pair of corresponding values of two vectors.

48. A method according to claim 46, where the metrics are weighted using an N×N weighting matrix.

49. Apparatus for searching for a match comprising means for storing a first set of attribute values (Fₙ) of at least one first entity (F, S) means for inputting a user-selected second set of attribute values (Mₙ, 54) relating to a second entity (M, 56), means for storing a distance formula which is a function of the degree of match between respective values of sets of attribute values, and applying the formula to the first and second sets to determine an overall degree of match between the first entity and the second entity.

50. Apparatus according to claim 47, wherein said first set of attribute values includes descriptive and/or functional words and/or phrases.
